(19) United States
(12) Patent Application Publication
(10) Pub. No.: US 2010/0030849 A1
(43) Pub. Date: Feb. 4, 2010

(54) Server apparatus for thin-client system

(75) Inventors: Ryo Miyamoto, Kawasaki (JP); Ryuichi Matsukura, Kawasaki (JP); Takashi Ohno, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/458,965

(22) Filed: Jul. 28, 2009

(30) Foreign Application Priority Data
Jul. 31, 2008 (JP) 2008-198592
Jun. 29, 2009 (JP) 2009-153812

(51) Int. Cl. G06F 15/16; G06F 3/048

(52) U.S. Cl. 709/203; 715/781

(57) ABSTRACT

A server apparatus for a thin-client system includes: a receiver unit that receives an input event from the terminal device; an input event processing unit that applies the received input event to particular processing related to the received input event; a region determiner unit that dynamically determines, as a desired region, a partial image region from a resultant display picture generated by the particular processing, so that the partial image region is affected by the particular processing; a region image generator unit that generates, as partial image information, partial image data and position data of the desired region, according to data of the display picture; and a transmitter unit that transmits the generated partial image information to the terminal device.

### CROSS-REFERENCE TO RELATED APPLICATIONS

This application is based upon and claims the benefit of priority of the prior Japanese Patent Application No. 2008-198592, filed on Jul. 31, 2008, and the prior Japanese Patent Application No. 2009-153812, filed on Jun. 29, 2009, the entire contents of which are incorporated herein by reference.

### FIELD

A certain aspect of the embodiments discussed herein is related generally to transfer of display data in a thin-client system, and in particular to transferring, from a server to a client, partial image data which is updated or changed in the server by processing an input from the client.

### BACKGROUND

A thin-client system, which includes a server and a plurality of clients interconnected via a network, is more widely used in recent years for security to prevent information leakage or the like.

In a known command transfer scheme as a way of implementing the thin-client system, a client transmits information related to an input operation such as a key input through a keyboard, to a server via a network. The client then receives, from the server, a response sequence of commands for rendering a desktop or frame picture which reflects or represents a result of processing the input operation. The client then renders a desktop picture in accordance with the sequence of commands. In another known picture transfer scheme as another way of implementing the thin-client system, a client receives, from a server, a response including data of a desktop picture which reflects a result of processing such an input operation. The client then displays the received desktop picture on a display screen of the client.

In the command transfer scheme, the server receives and processes the input operation information from the client, and then transmits to the client such a sequence of commands for rendering a resultant desktop picture. The transmitted sequence of commands is received by the client, as a response to the input operation information. The desktop picture is then rendered by software or hardware of the client in accordance with the received sequence of commands.

International Publication WO 01/008378, which corresponds to Japanese Laid-open Patent Application Publication No. JP 2003-505781-A, discloses a thin-client system. In this system, a client node receives user-provided input, produces a prediction of a server response to the user input, and then displays a prediction on a display screen. The display of the prediction provides a client user with a faster visual response to the user-provided input.

In the picture transfer scheme, the server receives and processes the input operation information from the client so as to reflect the content of the input operation information into the desktop picture. The server then compresses and encodes the desktop picture in accordance with an image compression and encoding scheme such as MPEG-2 and H 264, and then transmits the encoded compressed picture data to the client. Then, the client receives the encoded compressed desktop picture data as a response to the input operation information transmitted to the server, then decodes and decompresses the desktop picture data, and then displays the decompressed decoded desktop picture on the display screen.

Japanese Laid-open Patent Application Publication No. JP 2004-295304-A, discloses a server-based computing system. In this system, a first or previous partial region of a desktop picture within a specific range around a first mouse cursor position produced before a particular mouse operation, and then a second or current partial region of a desktop picture within a specific range around a second mouse cursor position produced after the particular mouse operation are sequentially transmitted together with respective first and second positions of the first and second regions to a client, before a current desktop picture is separately transmitted to the client. The client sequentially receives images of the partial regions, and overwrites, with the respective received partial images, the desktop picture in the respective partial regions on corresponding coordinate positions for sequential reproduction.

### SUMMARY

According to an aspect of the embodiment, a server apparatus for use in a thin-client system is provided that processes in accordance with input information received from a terminal device connectable via a network. The server apparatus includes: a receiver unit that receives an input event from the terminal device; an input event processing unit that applies the received input event to particular processing related to the received input event; a region determiner unit that dynamically determines, as a desired region, a partial image region from a resultant display picture generated by the particular processing, so that the partial image region is affected by the particular processing; a region image generator unit that generates, as partial image information, partial image data of the desired region and position data of the desired region, in accordance with data of the display picture; and a transmitter unit that transmits the generated partial image information to the terminal device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIGS. 1 and 1A-1E illustrate an example of a transmitting and receiving procedure between a client terminal and a server in a thin-client system for character inputs occurring in the client terminal and for quick responses to the character inputs related to fixed image regions including and surrounding a cursor position;

FIG. 2 illustrates an example of schematic configurations of a server and a client terminal connected to each other via a network in a thin-client system, in accordance with an embodiment of the present invention;

FIG. 3 is an example of a flow chart of quick response processing executed by the server in response to the key input information from the client terminal, in accordance with a first embodiment of the present invention;

FIGS. 4A and 4B illustrate examples of display images of the input regions of respective, first and second desktop pictures before and after the reflection of an input of a conversion key following inputs of hiragana characters into the first desktop picture in the kana-kanji conversion processing, i.e., before and after the kana-kanji conversion, in accordance with an embodiment of the present invention;

FIG. 5 illustrates an example of a configuration of the input and quick response processor unit and its relevant portions of the server for the quick response processing of the key input information in the kana-kanji conversion by the application as illustrated in FIGS. 4A and 4B, in accordance with an embodiment of the present invention;

FIG. 6 is an example of a flow chart of the quick response processing executed by the server in response to the key input information from the client terminal, in accordance with the configuration of the server of FIG. 5;

FIG. 7 is a more detailed example of a flow chart for Step 350 of FIG. 6;

FIGS. 8A and 8B illustrate examples of display images of the input region and an associated conversion candidate display region of respective desktop pictures before and after the reflection of an input of a conversion key, i.e., before the kana-kanji conversion and after tentative kana-kanji conversion (yet to be finally determined), in the kana-kanji conversion processing, in accordance with another embodiment of the invention;

FIG. 9 illustrates an example of a configuration of the input and quick response processor unit and its relevant portions of the server for the quick response processing of the key input information in the kana-kanji conversion by the application as illustrated in FIGS. 8A and 8B, in accordance with the another embodiment of the invention;

FIGS. 10A and 10B are an example of a flow chart of the quick response processing executed by the server in response to the key input information from the client terminal, in accordance with the configuration of the server of FIG. 9;

FIG. 11 illustrates an example of a configuration of the input and quick response processor unit and its relevant portions of the server for quick response processing of the key input information in processing an English alphanumeric input by the application, in accordance with a further embodiment of the invention;

FIGS. 12A and 12B are an example of a flow chart of the quick response processing executed by the server in response to the key input information from the client terminal, in accordance with the configuration of the server of FIG. 11;

FIG. 13 is a modification of the embodiment of FIG. 9, and illustrates an example of another configuration of the input and quick response processor unit and its relevant portions of the server for quick response processing of the key input information in the kana-kanji conversion by the application as illustrated in FIGS. 8A and 8B, in accordance with a further embodiment of the invention;

FIGS. 14A and 14B are an example of a flow chart of the quick response processing executed by the server in response to the key input information from the client terminal, in accordance with the configuration of the server of FIG. 13;

FIG. 15 is a modification of the embodiment of FIG. 5, and illustrates an example of a further configuration of the input and quick response processor unit and its relevant portions of the server for quick response processing of the key input information in the kana-kanji conversion by the application as illustrated in FIGS. 4A and 4B, in accordance with a still further embodiment of the invention;

FIGS. 16A and 16B are, an example of a flow chart of the quick response processing executed by the server in response to the key input information from the client terminal, in accordance with the configuration of the server of FIG. 15;

FIGS. 17A and 17B illustrate examples of display images of the input regions of respective desktop pictures before and after the reflection of a plurality of key inputs in the kana-kanji conversion processing, in accordance with a still further embodiment of the invention;

FIG. 18 illustrates an example of a configuration of the input and quick response processor unit and its relevant portions of the server for quick response processing of the key input information in the kana-kanji conversion by the application as illustrated in FIGS. 17A and 17B, in accordance with a still further embodiment of the invention;

FIGS. 19A and 19B are an example of a flow chart of the quick response processing executed by the server in response to the key input information from the client terminal, in accordance with the configuration of the server of FIG. 18;

FIGS. 20A and 20B illustrate examples of display images of the input region and an associated conversion candidate display region of respective desktop pictures before and after the reflection of an input of a conversion key, i.e., before the kana-kanji conversion and after tentative kana-kanji conversion in the kana-kanji conversion processing, in the server, in accordance with a still further embodiment of the invention;

FIG. 21 is a modification of the embodiment of FIG. 9, and illustrates an example of a still further configuration of the input and quick response processor unit and its relevant portions of the server for quick response processing of the key input information in the kana-kanji conversion by the application as illustrated in FIGS. 20A and 20B, in accordance with a still further embodiment of the invention;

FIGS. 22A and 22B are an example of a flow chart of the quick response processing executed by the server in response to the key input information from the client terminal, in accordance with the configuration of the server of FIG. 21;

FIGS. 23A and 23B illustrate examples of display images of the input regions of respective desktop pictures before and after the reflection of a response by the application to an alphanumeric key input “j”, following a hiragana character “fu” which is displayed in the input image region in response to input alphabet characters “fu” or an input hiragana character “fu” in the kana-kanji conversion processing, in accordance with a still further embodiment of the invention;

FIG. 24 illustrates an example of a configuration of the input and quick response processor unit and its relevant portions of the server for quick response processing of the key input information in the kana-kanji conversion by the application as illustrated in FIGS. 23A and 23B, in accordance with a still further embodiment of the invention;

FIG. 25 illustrates an example of elements of a table store in the table storage unit;

FIG. 26 illustrates an example of a state transition diagram for key inputs in the respective current input states of FIG. 25;

FIGS. 27A and 27B are an example of a flow chart of the quick response processing executed by the server in response to the key input information from the client terminal, in accordance with the configuration of the server of FIG. 24; and

FIG. 28 is an example of a detailed flow chart for Step 340 of FIG. 27A.

### DESCRIPTION OF THE PREFERRED EMBODIMENTS

In the thin-client system, the input operation information of the client is transmitted to the server via the network. Further, a response from the server is received also via the network. Thus, it may take a significant time before the input operation information of the client is reflected or accommodated in the display screen of the client.

In the picture transfer scheme, a client advantageously receives transferred data of a motion picture per se to be reproduced as a desktop picture on its display screen.

However, the picture transfer scheme produces a human-perceivable time delay between an input operation such as a key input operation on the client and responsive displaying of the desktop picture from the server on the display screen of the client. This delay is caused by the time-consuming processing for compressing and encoding the responsive desktop picture data as a heavy processing load in the server, and by time-consuming processing for decoding and decompressing the encoded compressed responsive desktop picture data as a heavy processing load in the client.

The client merely receives data of a desktop picture from the server and displays it, but does not have a client function of producing and rendering a predicted desktop picture, as described in International Publication WO 01/008378, and hence cannot reduce the response time to the user operation. International Publication WO 01/008378 does not provide a solution in processing of a motion picture in the thin-client system.

In the server-based computing system according to Japanese Laid-open Patent Application Publication No. JP 2004-295304-A, the regions have smaller areas and smaller amounts of information than the entire desktop pictures. Thus, the smaller region requires short time for transmission, and hence reduces the response time to the user operation.

However, in hypothetical application of the processing according to the server-based computing as described above to a character input system, a server may extracts or cuts out a first or previous partial image of a region including and surrounding a first input character within a desktop picture produced before a particular input operation, and then extracts a second or current partial image of a region including and surrounding a second input character within a desktop picture produced after the particular input operation, and then sequentially transmits these first and second extracted partial images to the client. The region including and surrounding each input character is a fixed region within a specific range around each cursor position. The client receives these respective transmitted partial images, then overwrites a corresponding input character image portion on the active display screen with the first received partial region image, then deletes a caret produced before the particular input operation, and then overwrites a corresponding input character image portion on the active display screen with the second received partial region image after the particular input operation, to render the second partial region image after the particular input operation on the display screen. Thus, the contents of the character input operations are sequentially reflected or incorporated into the display screen of the client. In the processing of a character, a mouse cursor has no change in size, and hence causes no problem in a region within the specific range around a mouse cursor position. However, different input character fonts have respective different or varying character sizes, which may cause a problem.

In the processing of character inputs, the kana-kanji conversion or kerning in the alphabets may produce variations in image areas or ranges of different input character fonts on the display screen. Thus, even if a server transmits, to a client, image data of a region for an input character within a specific range around a mouse cursor position in a desktop picture that reflects or represents a particular key input operation, only a part of the input character font within the region may be extracted, transmitted and reflected in the display screen of the client. Expansion of the extracted region of the desktop picture may solve the problem of the partial extraction and reflection. However, the expansion of the extracted region may increase the amount of information of the extracted region and hence the transmission time of the data.

The inventors have recognized that a desired image region of the desktop picture to be transmitted from the server to the client can be determined in accordance with the change of the range of an image region for each character input.

It is an object in one aspect of the embodiment to determine and transfer, to a client, a partial image region of a display picture that is affected by processing an input, before separately transferring the display picture.

According to the aspect of the embodiment, a partial image region of a display picture that is affected by processing an input can be determined and transferred to a client before the display picture is separately transferred. This reduces a time delay in an input operation that is perceivable to a user of the client.

Non-limiting preferred embodiments of the present invention will be described with reference to the accompanying drawings. Throughout the drawings, similar symbols and numerals indicate similar items and functions.

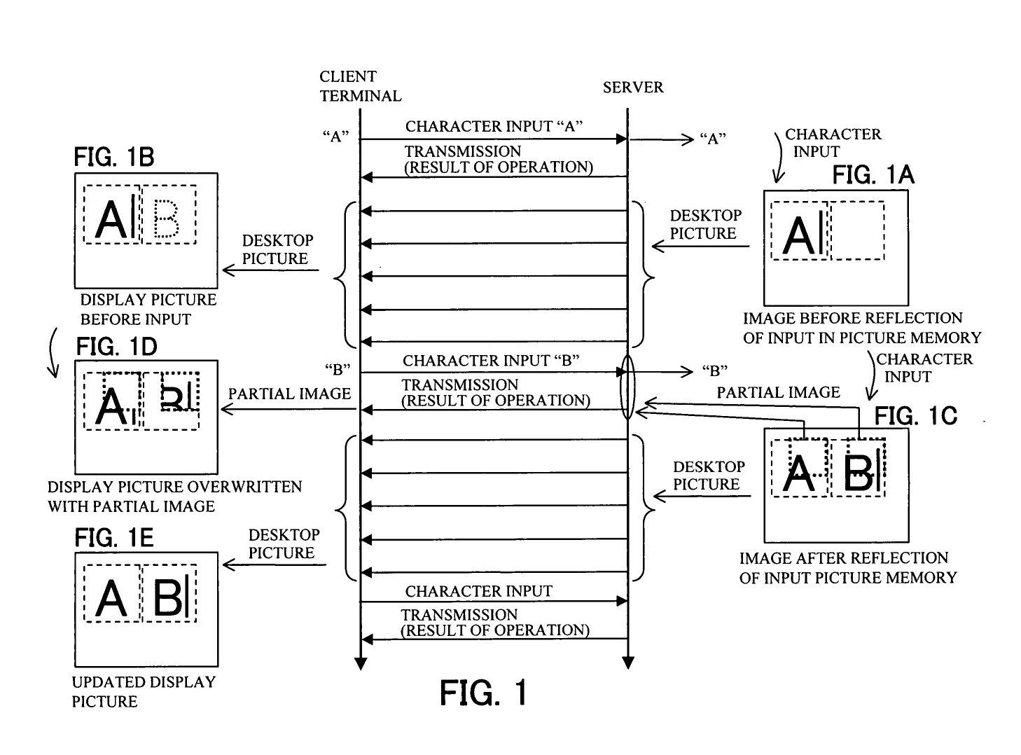

FIGS. 1 and 1A-1E illustrate an example of a transmitting and receiving procedure between a client terminal and a server in a thin-client system for character inputs occurring in the client terminal and for quick responses to the character inputs related to a fixed image region including and surrounding a cursor position.

In FIG. 1, a user inputs or enters, for example, an alphabetic character or letter “A” by operating an input device in the client terminal indicated on the left-hand side. In response, the client terminal transmits the character input data to the server indicated on the right-hand side. In response to the character input data, an application of the server processes the character input data so as to render a character font “A” and subsequently a caret “|” in an input region in a picture or frame memory of the server.

FIG. 1A illustrates an example of a desktop picture containing an example of a display image “A|”, as rendered in the input region of the picture memory of the server. This desktop picture is only an example of a display picture of image data. However, image data for a display picture is not limited to such image data for a desktop picture, and may be image data for a display picture for displaying on a display screen, on a display device being viewed by the user, a resultant image obtained by any processing in response to an input by a user.

The server then compresses and encodes the image data of the entire desktop picture containing the resultant display image “A|” which reflects or represents the input operation, and then transmits the encoded compressed image data to the client terminal in a particular cycle, for example, at a screen or frame refreshment rate of 30 times per sec (30/s). Then, the client terminal receives, decodes and decompresses the encoded compressed image data of the entire desktop picture, and then writes the decompressed decoded image data into a picture or frame memory of the client terminal for displaying the desktop picture of the image data of the picture memory on the display device.

FIG. 1B illustrates an example of a desktop picture containing the display image “A|” on the display device of the client terminal. The illustrated desktop picture includes an adjacent input region for a next alphabetic character “B”, as indicated by dotted character stroke lines.

In the picture of FIG. 1B, the user inputs the next alphabetic character “B” (in dotted stroke lines) through the keyboard in the client terminal. The client terminal then transmits the character input data to the server. In response to the character input data, the application of the server processes the character input data, so that the application deletes the caret “|” from the character image “A|” in the input region in the picture memory to provide the image data “A”, and then renders a character font “B” and a subsequent caret “|”.

FIG. 1C illustrates an example of an entire desktop picture containing the input region image “AB|”, as rendered in the picture memory of the server.

In response to the operation input data, for quick response, the server transmits, to the client terminal, image data of a fixed partial region of the display image “A” alone (excluding the caret) that includes and surrounds a first or previous cursor position, and also image data of a fixed partial region of the display image “B|” (including a caret) that includes and surrounds a current cursor position. The client terminal then overwrites respective corresponding regions of the previous desktop picture with the received image data of the respective partial regions, to thereby display an updated desktop picture on the display device.

FIG. 1D illustrates an example of an entire desktop picture containing the partly overwritten display image of the image “AB|” on the display device.

In FIG. 1D, the regions of the transmitted partial image data and the corresponding partial regions overwritten with the partial image data have a smaller area than that of each displayed input character font. Thus, the image display of the input region is incomplete on the display screen.

After that, the server performs time-consuming processing for compression and encoding. Then, as a response to the operation input data, the server transmits to the client terminal an entire desktop picture containing the input region image “AB|”. The client terminal receives and displays the entire desktop picture on the display device. As a result, a complete display screen of the response desktop picture appears on the display device with a time delay. This time delay is a perceivable level for a human, and the incomplete image display as described above may produce an artifact perceivable to a human.

FIG. 1E illustrates an example of an entire desktop picture on the display device which contains the input region image “AB|” as rendered in the input region in the picture memory.

For providing a quick display response to a key input through the keyboard, the server need determine an image region to be transmitted to the client terminal, in accordance with the varied range or area of the input region to be displayed for each key input.

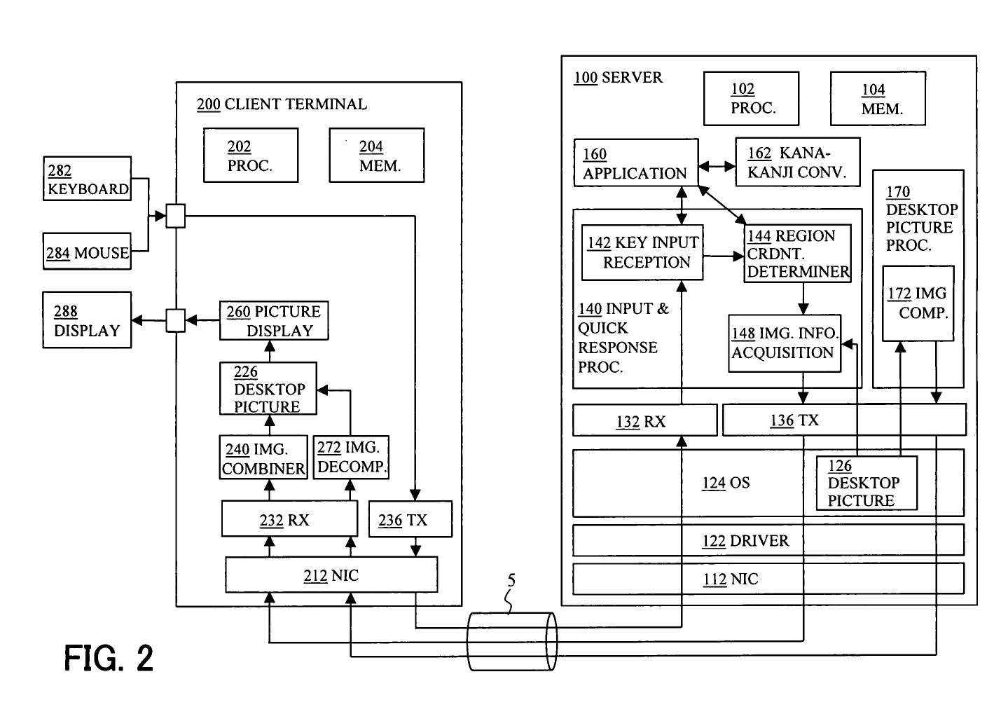

FIG. 2 illustrates an example of schematic configurations of a server 100 and a client terminal 200 connected to each other via a network 5 in a thin-client system, in accordance with an embodiment of the present invention.

The server 100 includes, as hardware, a processor 102, a memory 104, a network interface card (NIC) 112, a receiver unit (RX) 132, and a transmitter unit (TX) 136. The server 100 includes, as software, a driver 122 for the network interface card (NIC) 112, an OS (operating system) 124, an input and quick response processor unit 140, an application 160, a kana-kanji converter unit 162 as a character converter function, and a desktop picture processor unit 170. The application 160 includes a function of processing a character input.

The OS 124 has a desktop picture storage region 126, which may be a region in the memory 104. The input and quick response processor unit 140 includes a key input reception unit 142, an acquired region coordinate determiner unit 144, and an image information acquisition unit 148. The kana-kanji converter unit 162 may be implemented in the form of character conversion software. The desktop picture processor unit 170 includes an image compressor unit 172.

The client terminal 200 includes, as hardware, a processor 202, a memory 204, a network interface card (NIC) 212, a receiver unit (RX) 232, a transmitter unit (TX) 236, a keyboard 282 and a mouse or pointing device 284 as input devices, and a display device 288. The client terminal 200 includes, as software, an image combiner unit 240, an image decompressor unit 272, a desktop picture storage region 226, and a picture display device 260. The client terminal 200 may further include, as software, a local functional processor unit.

Referring to FIG. 2, in the client terminal 200, when a client user operates an input key through the keyboard 282 and the mouse 284, corresponding key input information is transmitted to the server 100 via the transmitter unit 236, the network interface card 212, and the network 5.

In the server 100, the key input information is provided to the input and quick response processor unit 140 via the network interface card 112, the driver 122, the OS 124, and the receiver unit 132. The key input reception unit 142 of the input and quick response processor unit 140 provides the key input information to the application 160. The application 160 processes the input information, and may display corresponding one or more input hiragana characters and further convert the one or more input hiragana characters into one or more kanji characters by using the kana-kanji converter unit 162, when necessary.

In response to the key input information from the input reception unit 142, the acquired region coordinate determiner unit 144 receives input response information from the application 160 or alternatively receives input response information from the API (application program interface) of the kana-kanji converter unit (character conversion software) 162 for the application 160, to thereby determine desired coordinates of an input image region on the desktop picture to be acquired. When the code type of the received key input information is of a one-byte code, the acquired region coordinate determiner unit 144 may acquire the coordinates of the input region from the operating system (OS) 124. Further, when the code type of key input information is other than a one-byte code type, the acquired region coordinate determiner unit 144 may acquire the coordinates of the input region from the kana-kanji converter unit for the application 160.

In accordance with the determined coordinates, the image information acquisition unit 148 acquires corresponding partial image data from the desktop picture storage region 126 of the OS 124. The image information acquisition unit 148 then encodes the image data and the coordinate data as image information without compression into encoded image information, and then transmits the encoded image information to the client terminal 200 via the transmitter unit 136, the OS 124, the driver 122, the network interface card 112, and the network 5. Alternatively, the image data and the coordinate data as image information may be compressed into compressed image information before it is encoded.

In the client terminal 200, the partial image information is provided to the image combiner unit 240 via the network interface card 212 and the receiver unit 232. The image combiner unit 240 decodes the received partial image information, and then partly overwrites the desktop picture in the desktop picture storage region 226 with the decoded partial image information. The picture display device 260 provides the combined desktop picture in the desktop picture storage region 226 to the display device 288 for displaying it.

In the server 100, in the conventional manner, the desktop picture processor unit 170 cyclically retrieves the image information of the entire desktop picture in the desktop picture storage unit 126, and then compresses the image information by using the image compressor unit 172. The desktop picture processor unit 170 then transmits the compressed image information to the client terminal 200 via the transmitter unit 136, the OS 124, the driver 122, the network interface card 112, and the network 5.

In the client terminal 200, the compressed image information of the entire desktop picture is provided to the image decompressor unit 272 via the network interface card 212 and the receiver unit 232. In the conventional manner, the image decompressor unit 272 decompresses the received image to reproduce non-compressed or uncompressed image information, and then writes the reproduced image information into the desktop picture storage region 226. The picture display device 260 provides the entire desktop picture in the desktop picture storage region 226 to the display device 288 for displaying it.

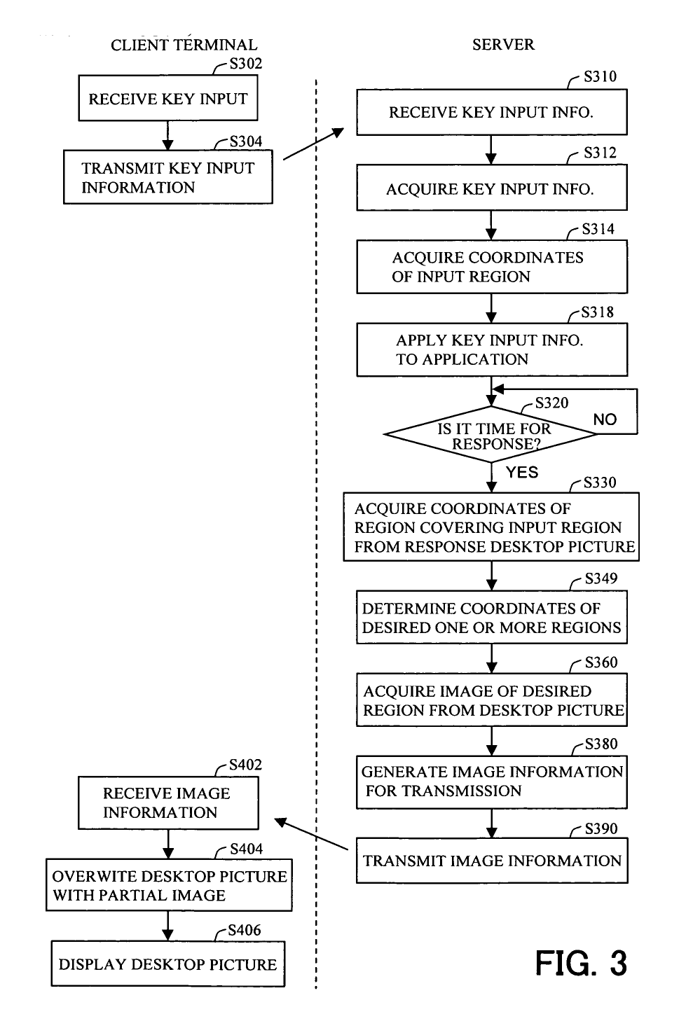

FIG. 3 is an example of a flow chart of quick response processing executed by the server 100 in response to the key input information from the client terminal 200, in accordance with a first embodiment of the present invention.

At Step 302, the transmitter unit 236 of the client terminal 200 receives information related to a key input generated by a user. At Step 304, the transmitter unit 236 transmits the key input information to the server 100 via the network interface card 212.

At Step 310, the receiver unit 132 of the server 100 receives the key input information via the network interface card 112, the driver 122, and the OS 124.

At Step 312, the input reception unit 142 of the input and quick response processor unit 140 acquires the key input information, and then provides the key input information to the application 160. At Step 314, before applying the key input, the acquired region coordinate determiner unit 144 of the input and quick response processor unit 140 acquires the coordinates of the current input image region from the API (application program interface) of the kana-kanji converter unit 162 for the application 160. At Step 318, the application 160 applies the key input information to perform corresponding processing. Steps 310 to 314 and 318 are according to the conventional processing in the server 100.

At Step 320, for quick response, the image information acquisition unit 148 determines whether it is time to acquire an image for the quick response processing, or whether a timer indicates an elapse of a given time period. Step 320 is repeated until it becomes time to acquire an image. The time to acquire an image may be, for example, when a particular time period (e.g., 1/30 to 1/60 s) has elapsed after application of the key input information to the application 160. On the other hand, transmission of compressed information of the entire desktop picture generated in the desktop picture processor unit 170 in the conventional manner or slow response occurs in a cycle period of a particular time length (e.g., 1/30 to 1/60 s).

If it is determined at Step 320 that it is time to acquire an image, the acquired region coordinate determiner unit 144 at Step 330 acquires, from the API (application program interface) of the kana-kanji converter unit 162 for the application 160, data of coordinate positions of a desired image region covering or containing the resultant input image region of the desktop picture after the response from the application 160 is reflected into the desktop picture (in the desktop picture storage region 126). In other words, the resultant input image region is a reflection of the response from the application 160 into the desktop picture.

At Step 349, the acquired region coordinate determiner unit 144 determines the coordinate positions of one or more desired ones of image regions: the previous input image region of the desktop picture before the response from the application 160 is reflected in the desktop picture, and the resultant input image region of the desktop picture after the response from the application 160 is reflected into the desktop picture and a further resultant image region of a changed display image portion of the desktop picture that is a further reflection of the response. At Step 360, the image information acquisition unit 148 acquires data of the image of the desired image region from the desktop picture storage region 126 of the picture memory (a region in the memory 104) corresponding to the determined coordinates.

At Step 380, the image information acquisition unit 148 generates and provides the acquired coordinate data and image data as the image information to the transmitter unit 136. At Step 390, the transmitter unit 136 transmits the generated image information to the client terminal 200.

In the client terminal 200, the receiver unit 232 at Step 402 receives the transmitted image information. At Step 404, in accordance with the coordinate data, the image combiner unit 240 overwrites the corresponding input image region of the desktop picture in the desktop picture storage region 226 in the picture memory (a region in the memory 204) with the partial image data of the image information. At Step 406, the picture display device 260 displays the resultant combined desktop picture in the desktop picture storage region 226 onto the display device 288.

For example, in processing alphabet inputs for displaying with the kerning function, individual display image regions or areas of the different alphabet character fonts such as “f”, “u”, “j” and “i” are not the same, and may vary depending on the individual alphabets. For example, the alphabet font “u” has a wider character width, while the alphabet font “i” has a narrower character width. Further, for example, the alphabet font “f” has a higher character font position, while the alphabet font “j” has a lower character font position. Thus, even if the server 100 acquires and transmits, to the client terminal 200, only the image of a fixed image region including and surrounding the cursor position in the input region of the desktop picture which reflects or represents a result of processing the key input operation information by the application 160 of the server 100, the display screen of the client terminal 200 may not sufficiently reflect the result of the processing by the application 160.

In order to provide a quick response with a partial image which sufficiently reflects the result of the response by the application 160 to the key input operation information, a desired partial image region of the desktop picture to be transmitted from the server 100 to the client terminal 200 may need to be determined in accordance with variations in the area or range of the display image region for the respective character inputs on the desktop picture.

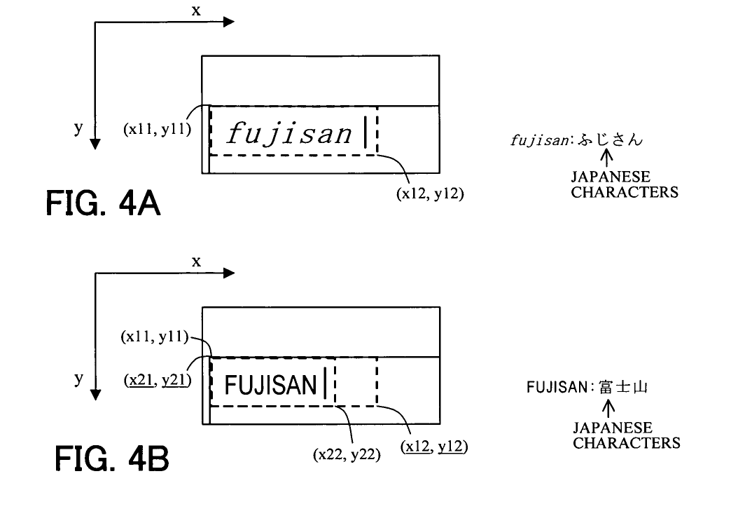

FIGS. 4A and 4B illustrate examples of display images of the input regions of respective, first and second desktop pictures before and after the reflection of an input of a conversion key (e.g., an input of a space key) following inputs of hiragana characters into the first desktop picture in the kana-kanji conversion processing, i.e., before and after the kana-kanji conversion, in accordance with an embodiment of the present invention.

In FIG. 4A, the range of the display image region for a string of four kana or hiragana characters “fujisan” before the kana-kanji conversion is defined by a pair of coordinate positions {(x11, y11), (x12, y12)}, which correspond to respective vertices at an upper left corner and a lower right corner of a rectangular with dashed lines. In FIG. 4B, the range of the display image region for a string of three kanji characters “FUJISAN” (meaning Mt. Fuji) after the kana-kanji conversion is defined by a pair of coordinate positions {(x21, y21), (x22, y22)}. For the purpose of describing and illustrating the embodiment in English, the string of hiragana characters is expressed or transliterated in wider lower-case italic alphabets, while the string of kanji characters is expressed or transliterated in narrower upper-case alphabets.

Thus, in order to sufficiently reflect the display image of the three kanji characters “FUJISAN” after the kana-kanji conversion into the desktop picture of the client terminal 200, the server 100 need extract, from the desktop picture, a combined display image “FUJISAN ” (i.e., the kanji character string image “FUJISAN” and a following blank space image “ ” in combination) in a desired image region in the larger range {(x21, y21), (x12, y12)} that covers the two, hiragana and kanji character ranges described above. Then, the server 100 need transmit the combined display image to the client terminal 200, so that the previous input region display image of the string of four hiragana characters “fujisan” on the previous desktop picture is overwritten with the combined display image. If the server 100 extracts the input region display image of the three kanji characters “FUJISAN” alone in the narrower range {(x21, y21), (x22, y22)} so that the client terminal 200 overwrites the previous desktop picture with the extracted image, then the client terminal 200 overwrites only the partial region display image for the string of three hiragana characters “fujisa” with the extracted image, so that the input region display image includes the string of three kanji characters “FUJISAN” and the one hiragana character “n” for the combined input region image “FUJISANn”, which does not sufficiently reflect the result of the processing by the server 100.

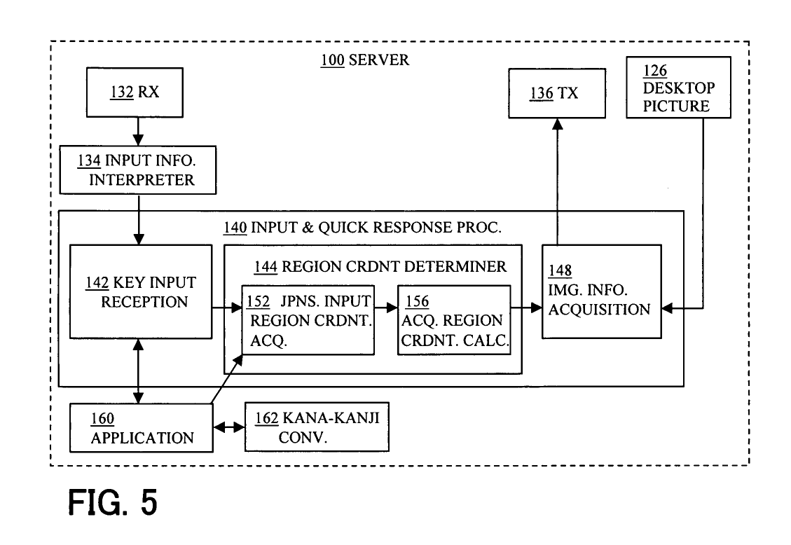

FIG. 5 illustrates an example of a configuration of the input and quick response processor unit 140 and its relevant portions of the server 100 for the quick response processing of the key input information in the kana-kanji conversion by the application 160 as illustrated in FIGS. 4A and 4B, in accordance with an embodiment of the present invention.

Referring to FIG. 5, in the input and quick response processor unit 140 of the server 100, the acquired region coordinate determiner unit 144 includes a Japanese (Japanese character) input region coordinate acquisition unit 152 and an acquired region coordinate calculator unit 156.

The input reception unit 142 receives significant interpreted key input information that is received by the receiver unit 132 and interpreted by an input information interpreter unit 134, and then provides the interpreted key input information to the Japanese input region coordinate acquisition unit 152. In response to the reception of the key input information from the input reception unit 142, the Japanese input region coordinate acquisition unit 152 acquires, from the API of the kana-kanji converter unit 162 for the application 160, the coordinates of the input image region before and after the processing of the key input information, and then provides the acquired coordinates to the acquired region coordinate calculator unit 156. In accordance with the acquired coordinates of these input regions, the acquired region coordinate calculator unit 156 calculates a pair of coordinate positions of a larger desired input image region to be acquired, and then provides the calculated coordinates of the desired image region to the image information acquisition unit 148.

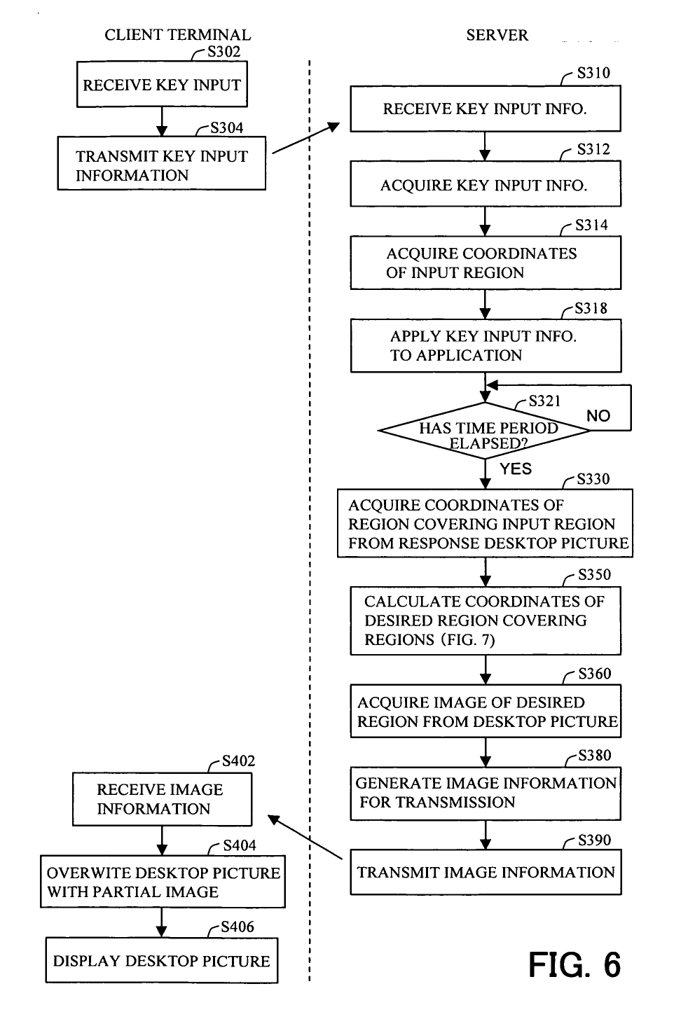

FIG. 6 is an example of a flow chart of the quick response processing executed by the server 100 in response to the key input information from the client terminal 200, in accordance with the configuration of the server 100 of FIG. 5.

Steps 302 to 304 executed by the client terminal 200 are similar to those of FIG. 3, and hence will not be described again.

Steps 310 to 318 executed by the server 100 are similar to those of FIG. 3, and hence will not be described again. At Step 314, from the API of the kana-kanji converter unit 162 for the application 160, the coordinate acquisition unit 152 of the acquired region coordinate determiner unit 144 acquires the coordinates of the current input image region before the processing of the key input information.

At Step 321, the Japanese input region coordinate acquisition unit 152 of the acquired region coordinate determiner unit 144 determines whether a given time period (e.g., 1/30 s) has elapsed in the timer after the application of the key input information to the application 160. Thus, the Japanese input region coordinate acquisition unit 152 waits for the time when the key input information is processed by the application 160 and then the desktop picture in the desktop picture storage region 126 is updated. Step 321 is repeated until the given time period elapses. If it is determined at Step 321 that the given time period has elapsed, the procedure goes to Step 330.

At Step 330, the Japanese input region coordinate acquisition unit 152 of the acquired region coordinate determiner unit 144 acquires, from the API of the kana-kanji converter unit 162 for the application 160, the coordinates of the resultant input region which reflects the resultant response of processing of the key input information by the application 160 into the desktop picture.

At Step 350, the acquired region coordinate calculator unit 156 of the acquired region coordinate determiner unit 144 calculates the coordinate positions of a larger desired image region that covers both the input regions before and after the reflection of the resultant response by the application 160 into the desktop picture.

Steps 360 to 390 are similar to those of FIG. 3.

Steps 402 to 406 are similar to those of FIG. 3.

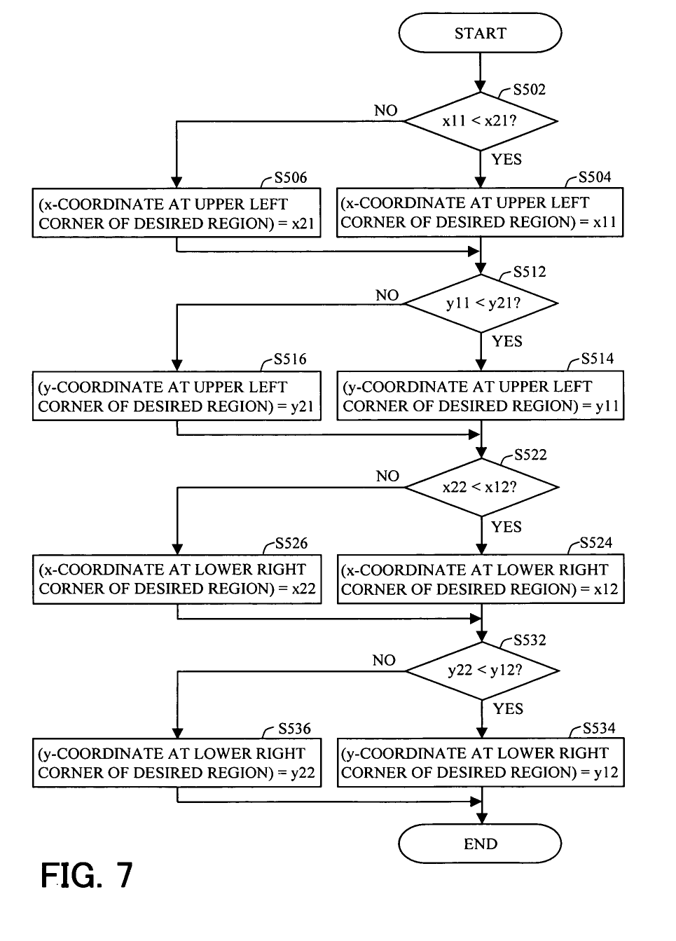

FIG. 7 is a more detailed example of a flow chart for Step 350 of FIG. 6. In this flow chart, in accordance with a first display image region (coordinates) {(x11, y11), (x12, y12)} for a string of hiragana characters (e.g., “fujisan”) in the input image region before the kana-kanji conversion and with a second display image region {(x21, y21), (x22, y22)} for a string of kanji characters (e.g., “FUJISAN”) after the kana-kanji conversion, a larger image region which covers these two display image regions is determined as a desired image region. In FIG. 7, it is assumed that the origin 0 is located at the upper left corner of the desktop picture. Thus, the x and y coordinates have respective positive values.

At Step 502, the acquired region coordinate determiner unit 144 determines whether the first x-coordinate “x11” of the first image region is smaller than the first x-coordinate “x21” of the second image region. If it is determined that the first x-coordinate “x11” of the first image region is smaller, the acquired region coordinate determiner unit 144 at Step 504 determines the x-coordinate “x11” as the first x-coordinate of the larger desired image region. If it is determined that the first x-coordinate “x11” of the first image region is not smaller, the acquired region coordinate determiner unit 144 at Step 506 determines the x-coordinate “x21” as the first x-coordinate of the larger desired image region. Thus, the selected first x-coordinate is located at the upper left vertex of the larger image region and has the smaller value.

At Step 512, the acquired region coordinate determiner unit 144 determines whether the first y-coordinate “y11” of the first image region is smaller than the first y-coordinate “y21” of the second image region. If it is determined that the first y-coordinate “y11” of the first image region is smaller, the acquired region coordinate determiner unit 144 at Step 514 determines the y-coordinate “y11” as the first y-coordinate of the larger desired image region. If it is determined that the first y-coordinate “y11” of the first image region is not smaller, the acquired region coordinate determiner unit 144 at Step 516 determines the y-coordinate “y21” as the first y-coordinate of the larger desired image region. Thus, the selected first y-coordinate is located at the upper left vertex of the larger image region and has the larger value.

At Step 522, the acquired region coordinate determiner unit 144 determines whether the second x-coordinate “x22” of the second image region is smaller than the second x-coordinate “x12” of the first image region. If it is determined that the second x-coordinate “x22” of the second image region is smaller, the acquired region coordinate determiner unit 144 at Step 524 determines the x-coordinate “x12” as the second x-coordinate of the larger desired image region. If it is determined that the second x-coordinate “x22” of the second image region is not smaller, the acquired region coordinate determiner unit 144 at Step 526 determines the x-coordinate “x22” as the second x-coordinate of the larger desired image region. Thus, the selected second x-coordinate is located at the lower right vertex of the larger image region and has the larger value.

At Step 532, the acquired region coordinate determiner unit 144 determines whether the second y-coordinate “y22” of the second image region is smaller than the second y-coordinate “y12” of the first image region. If it is determined that the second y-coordinate “y22” of the second image region is smaller, the acquired region coordinate determiner unit 144 at Step 534 determines the y-coordinate “y12” as the second y-coordinate of the larger desired image region. If it is determined that the second y-coordinate “y22” of the second image region is not smaller, the acquired region coordinate determiner unit 144 at Step 536 determines the y-coordinate “y22” as the second y-coordinate of the larger desired image region. Thus, the selected second y-coordinate is located at the lower right vertex of the larger image region and has the smaller value.

If there are three or more display image regions are to be covered by a larger image region, a tentative desired image region determined for the two display image regions in accordance with the flow chart of FIG. 7 may be used as a new display image region. Then the flow chart of FIG. 7 may be applied again to the tentative desired image region and any one of the remaining display image regions. By repeating this processing, the coordinates of an ultimate larger image region that covers the three or more display image regions are determined.

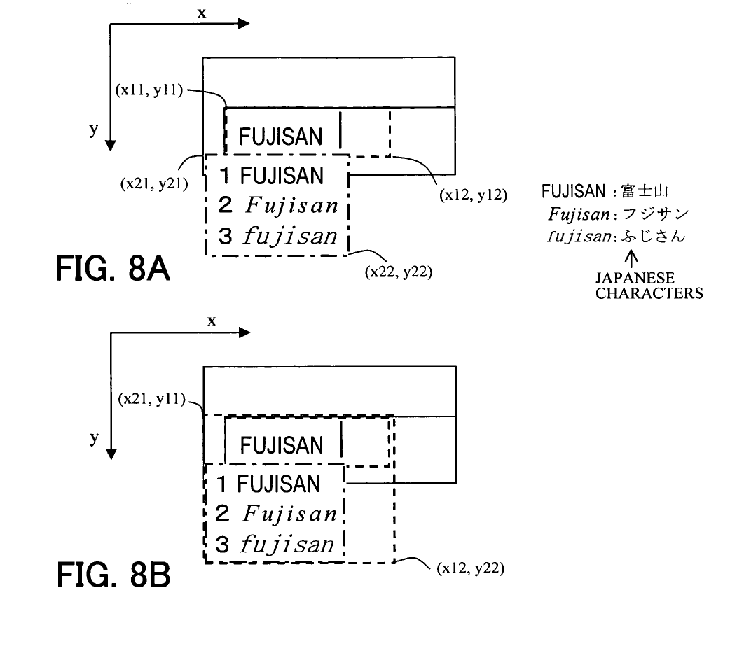

FIGS. 8A and 8B illustrate examples of display images of the input region and an associated conversion candidate display region of respective desktop pictures before and after the reflection of an input of a conversion key (e.g., an input of a space key), i.e., before the kana-kanji conversion and after tentative kana-kanji conversion (yet to be finally determined), in the kana-kanji conversion processing, in accordance with another embodiment of the invention. In FIGS. 8A and 8B, a pair of coordinate positions of a desired image region is determined so as to cover both the input image region of FIG. 4B and the additional display image region for displaying a window of conversion candidate characters or character strings.

In FIG. 8A, in accordance with the ranges of the input regions for the string of four hiragana characters “fujisan” yet to be converted (FIG. 4A) and for the string of three kanji characters “FUJISAN” after the tentative conversion (not yet finally determined), a desired image region that covers the two image regions is calculated in accordance with the process of FIG. 7. The resultant desired image region is defined by a pair of coordinate positions {(x11, y11), (x12, y12)}, which corresponds to the pair of coordinate positions {(x21, y21), (x12, y12)} of FIG. 4B. Further, the range of the display tentative image region of the list of conversion candidate character strings is defined by a pair of coordinate positions {(x21, y21), (x22, y22)}. In FIG. 8B, a larger desired tentative image region which reflects the key input information is defined by a pair of coordinate positions {(x21, y12), (x12, y22)}.

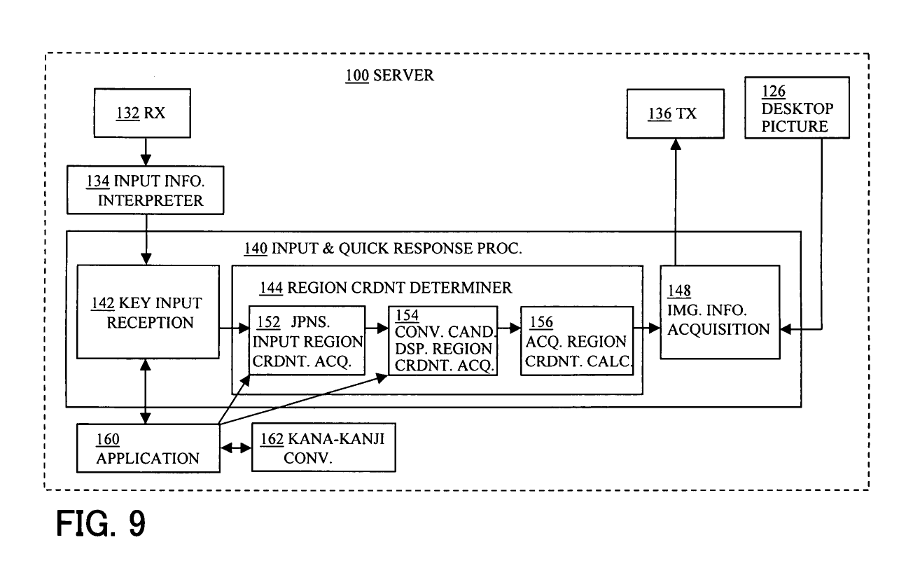

FIG. 9 illustrates an example of a configuration of the input and quick response processor unit 140 and its relevant portions of the server 100 for the quick response processing of the key input information in the kana-kanji conversion by the application 160 as illustrated in FIGS. 8A and 8B, in accordance with the another embodiment of the invention.

Referring to FIG. 9, in the input and quick response processor unit 140 of the server 100, the acquired region coordinate determiner unit 144 includes a conversion candidate display region coordinate acquisition unit 154, in addition to the Japanese input region coordinate acquisition unit 152 and the acquired region coordinate calculator unit 156.

In response to the receipt of the key input information from the input reception unit 142, the Japanese input region coordinate acquisition unit 152 acquires, from the API of the kana-kanji converter unit 162 for the application 160, the coordinates of the input image regions before and after the processing of key input information, and then provides the acquired coordinates to the acquired region coordinate calculator unit 156. The conversion candidate display region coordinate acquisition unit 154 acquires the coordinates of the conversion candidate display region from the API of the kana-kanji converter unit 162 for the application 160, and then provides the acquired coordinates to the acquired region coordinate calculator unit 156. Then, in accordance with the input image region coordinates and with the conversion candidate display region coordinates, the acquired region coordinate calculator unit 156 calculates coordinates or a pair of coordinate positions of the desired larger image region to be acquired, and then provides the calculated coordinates of the desired larger image region to the image information acquisition unit 148. The other elements and operations of the input and quick response processor unit 140 are similar to those of FIG. 5.

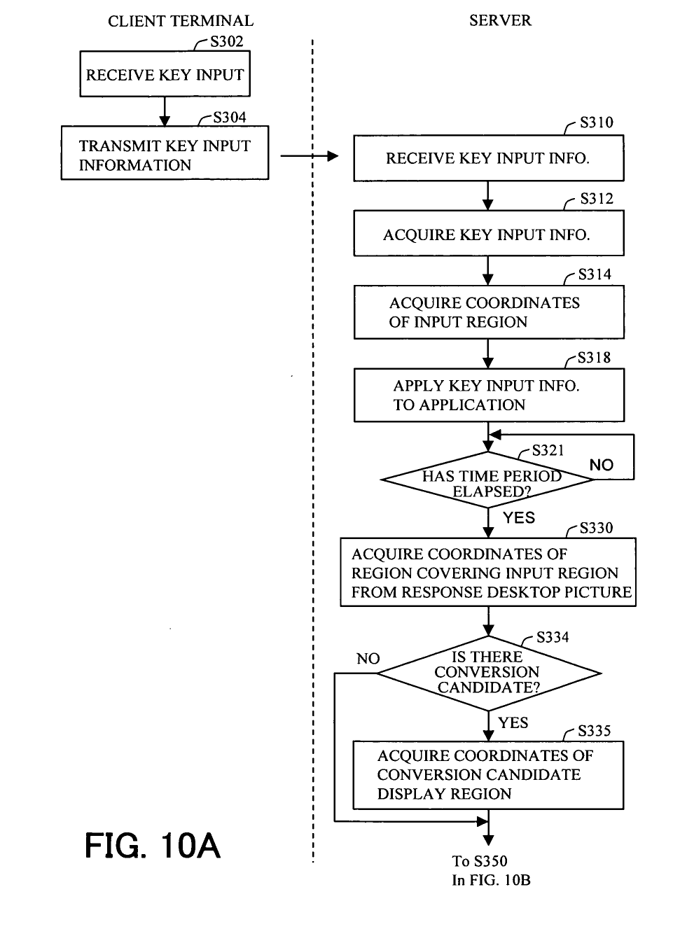

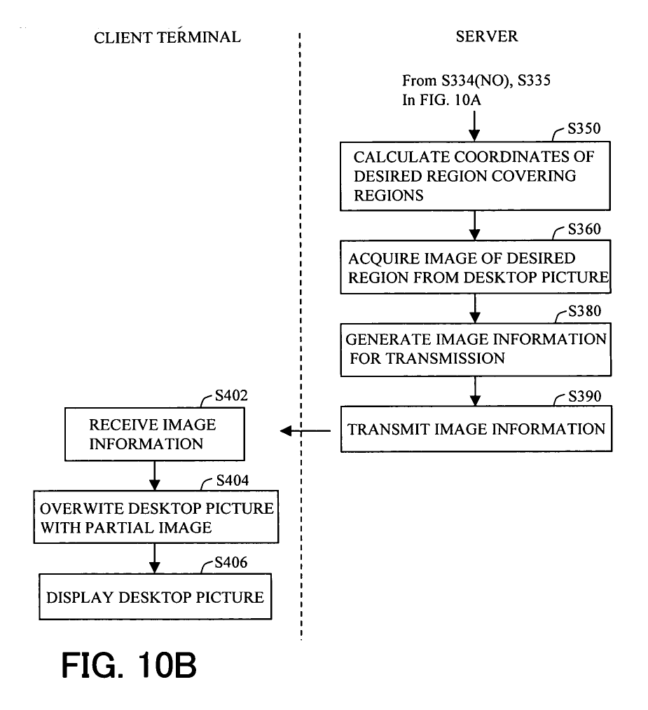

FIGS. 10A and 10B are an example of a flow chart of the quick response processing executed by the server 100 in response to the key input information from the client terminal 200, in accordance with the configuration of the server 100 of FIG. 9.

Referring to FIG. 10A, Steps 302 to 304 executed by the client terminal 200 are similar to those of FIG. 6.

Steps 310 to 330 executed by the server 100 are similar to those of FIG. 6.

At Step 334 following Step 330, the conversion candidate display region coordinate acquisition unit 154 of the acquired region coordinate determiner unit 144 determines whether there is one or more conversion candidates to be displayed provided by the application 160. If it is determined that there is no conversion candidate, the procedure goes to Step 350. If it is determined that there is one or more conversion candidates, the conversion candidate display region coordinate acquisition unit 154 at Step 335 acquires the coordinate positions of the conversion candidate display region from the API of the kana-kanji converter unit 162 for the application 160.

Referring to FIG. 10B, at Step 350, the acquired region coordinate calculator unit 156 of the acquired region coordinate determiner unit 144 calculates the coordinates of a desired larger region which covers the input image regions before and after the reflection of the response by the application 160 into the desktop picture, and the conversion candidate display region. In this case, the processing of FIG. 7 may be repeated twice. Steps 360 to 390 are similar to those of FIG. 6.

Steps 402 to 406 are similar to those of FIG. 6.

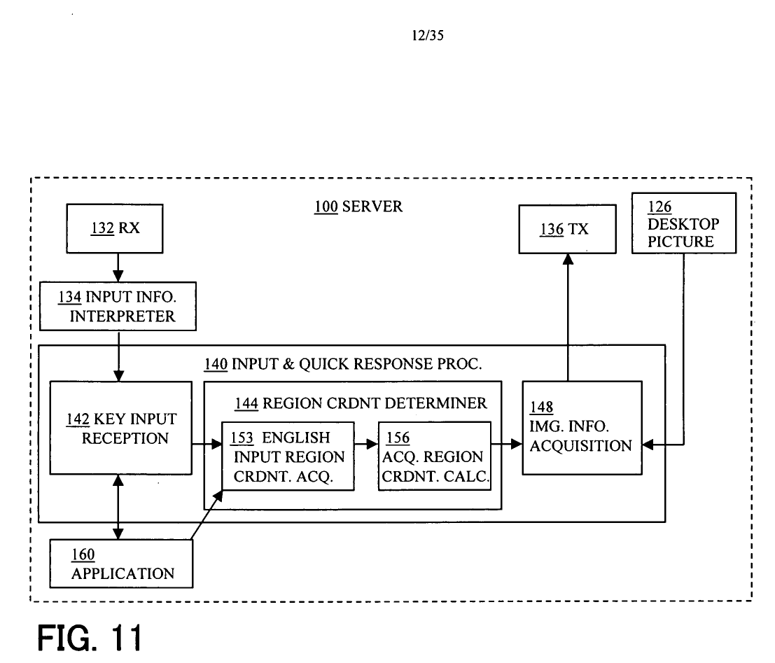

FIG. 11 illustrates an example of a configuration of the input and quick response processor unit 140 and its relevant portions of the server 100 for quick response processing of the key input information in an English alphanumeric input processing by the application 160, in accordance with a further embodiment of the invention.

Referring to FIG. 11, in the input and quick response processor unit 140 of the server 100, the acquired region coordinate determiner unit 144 includes an English (alphanumeric) input region coordinate acquisition unit 153 and an acquired region coordinate calculator unit 156. In this case, the kana-kanji converter unit 162 is not used.

In accordance with the use or nonuse of the kerning processing, the English input region coordinate acquisition unit 153 acquires the coordinate positions of a display image region corresponding to a given number of characters from the caret position. The kerning is processing for adjusting character spacing for particular combinations or strings of character fonts to achieve visually improved appearances. The other elements and operations of the input and quick response processor unit 140 are similar to those of FIG. 5.

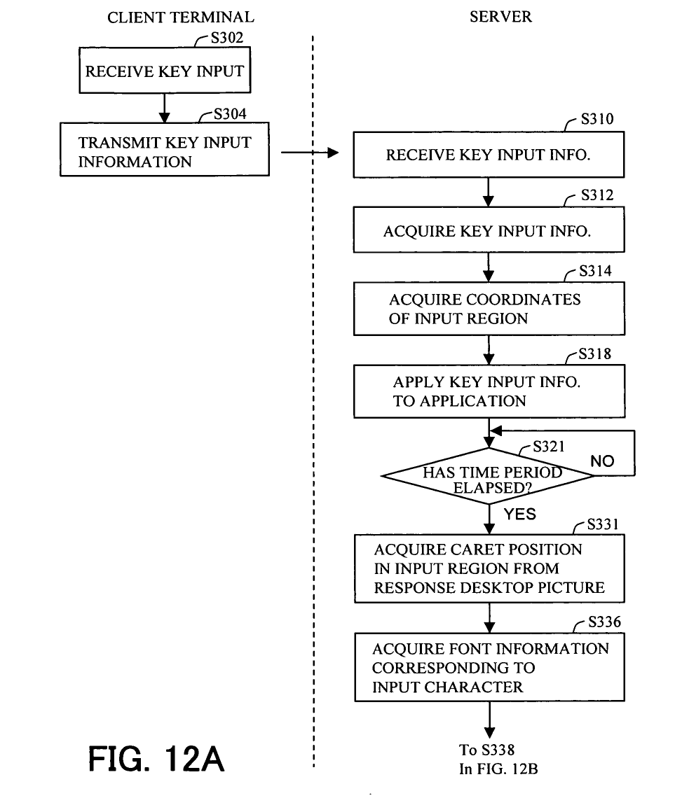

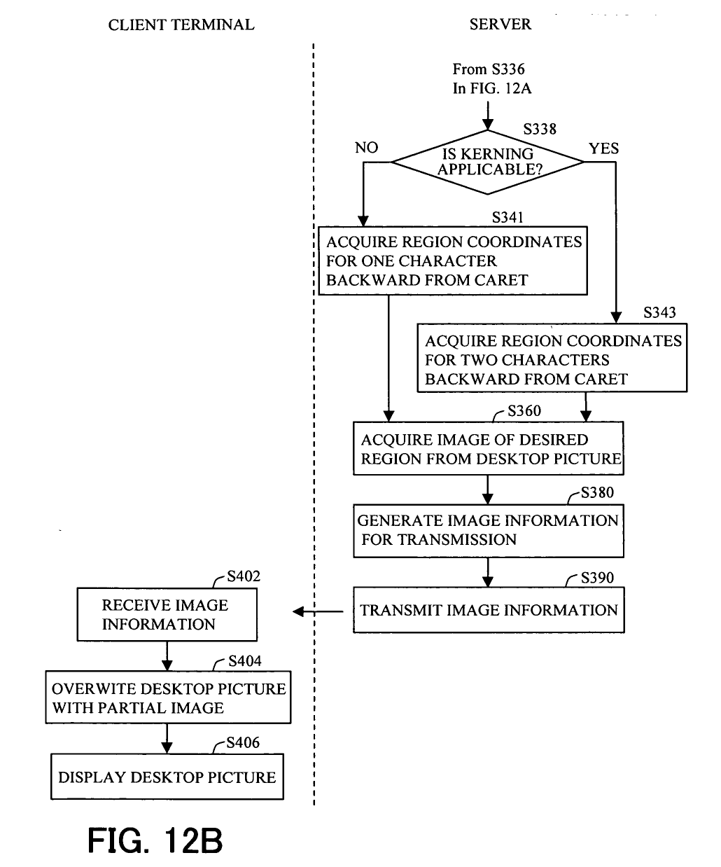

FIGS. 12A and 12B are an example of a flow chart of the quick response processing executed by the server 100 in response to the key input information from the client terminal 200, in accordance with the configuration of the server 100 of FIG. 11.

Referring to FIG. 12A, Steps 302 to 304 executed by the client terminal 200 are similar to those of FIG. 6.

Steps 310 to 321 executed by the server 100 are similar to those of FIG. 6.

At Step 331 following the YES branch of Step 321, the English input region coordinate acquisition unit 153 of the input and quick response processor unit 140 acquires, from the application 160, the coordinate position of the caret “I” in the input image region of the desktop picture after the response from the application 160 is reflected into the desktop picture.

At Step 336, the English input region coordinate acquisition unit 153 acquires, from the application 160, font information corresponding to the input character being inputted.

Referring to FIG. 12B, at Step 338, the English input region coordinate acquisition unit 153 determines whether kerning is applicable to the acquired font information. If it is determined that kerning is not applicable, the English input region coordinate acquisition unit 153 at Step 341 acquires, as a desired image region, the coordinate positions of the image region for one character font backward (leftward) from the caret position. If it is determined that kerning is applicable, the English input region coordinate acquisition unit 153 at Step 343 acquires, as a desired image region, the coordinate positions of the image region for two character fonts backward (leftward) from the caret position. Thus, it acquires the coordinate positions of a display image region for the two character fonts which have a narrowed space between them by the kerning.

At Step 360 following Step 341 or 343, the image information acquisition unit 148 acquires the image of the desired input region from the desktop picture storage region 126 in the picture memory which corresponds to the acquired coordinate positions.

Steps 380 to 390 are similar to those of FIG. 9.

Steps 402 to 406 executed by the client terminal 200 are similar to those of FIG. 3.

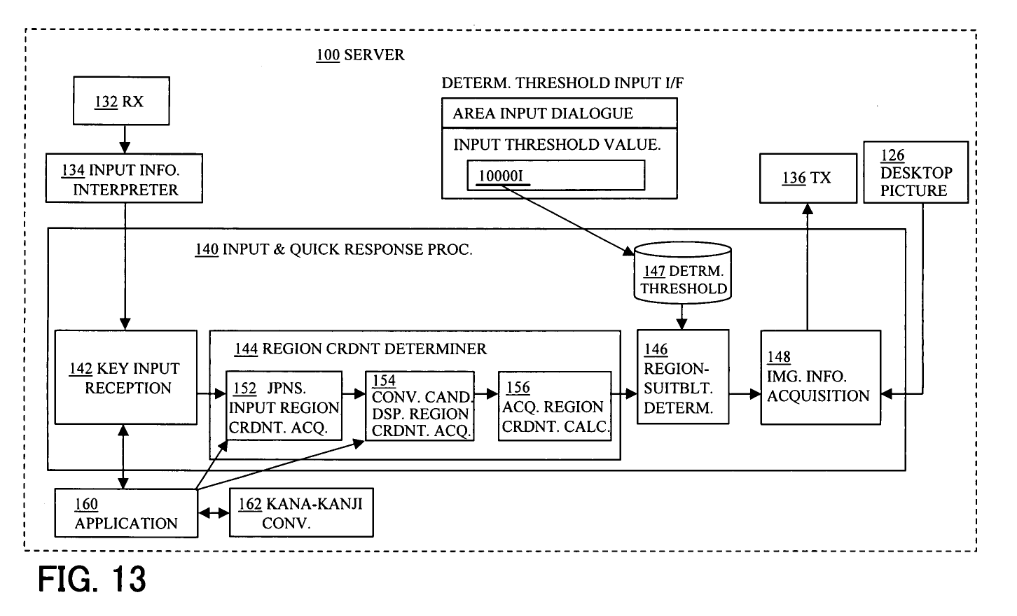

FIG. 13 is a modification of the embodiment of FIG. 9, and illustrates an example of another configuration of the input and quick response processor unit 140 and its relevant portions of the server 100 for quick response processing of the key input information in the kana-kanji conversion by the application 160 as illustrated in FIGS. 8A and 8B, in accordance with a further embodiment of the invention. This embodiment is applicable also to other embodiments illustrated in FIGS. 5 and 11 and described below. This configuration is applicable also to other cases in which, for example, one key input changes a large display image region. For example, this configuration is applicable to a case in which the kerning or the like in an English alphanumeric input changes the display image of a plurality of lines of English text.

In FIG. 13, the input and quick response processor unit 140 of the server 100 includes a determination threshold storage unit 147 (a region in the memory 104) and a region-suitability determiner unit 146 in addition to the key input reception unit 142, the acquired region coordinate determiner unit 144, and the image information acquisition unit 148.

An administrator of the server 100 inputs, through an input device (not illustrated) for the server 100 on a determination threshold input interface display screen or window displayed on a display device (not illustrated) of the server 100, a value of a threshold area (in the unit of square point, square pixel, square millimeter, or square milli-inch) of a desired image region as the criteria of determining the suitability of a desired image region for the quick response, to pre-store the threshold area value into the determination threshold storage unit 147 (a region in the memory 104). This area is preferably determined such that the amount of information in the area is sufficiently smaller than the amount of the compressed information of the entire desktop picture.

The region-suitability determiner unit 146 calculates the area of the desired image region in accordance with the coordinates of the desired image region determined by the acquisition region coordinate determiner unit 144. The region-suitability determiner unit 146 then compares the calculated area with the threshold area value in the determination threshold value storage unit 147. If the area of the desired image region exceeds the threshold area value, the region-suitability determiner unit 146 terminates the processing without performing the quick response to the key input information. If the area of the desired image region does not exceed the threshold area value, the region-suitability determiner unit 146 provides the coordinate positions of the desired image region to the image information acquisition unit 148. Thus, an excessively large amount of information of the partial image to be transmitted is not transmitted for the quick response, and hence the quick response does not occur in this case. This prevents transmission of a larger load of the partial image load than that of the entire desktop picture. The other elements and operations of the input and quick response processor unit 140 are similar to those of FIG. 9.

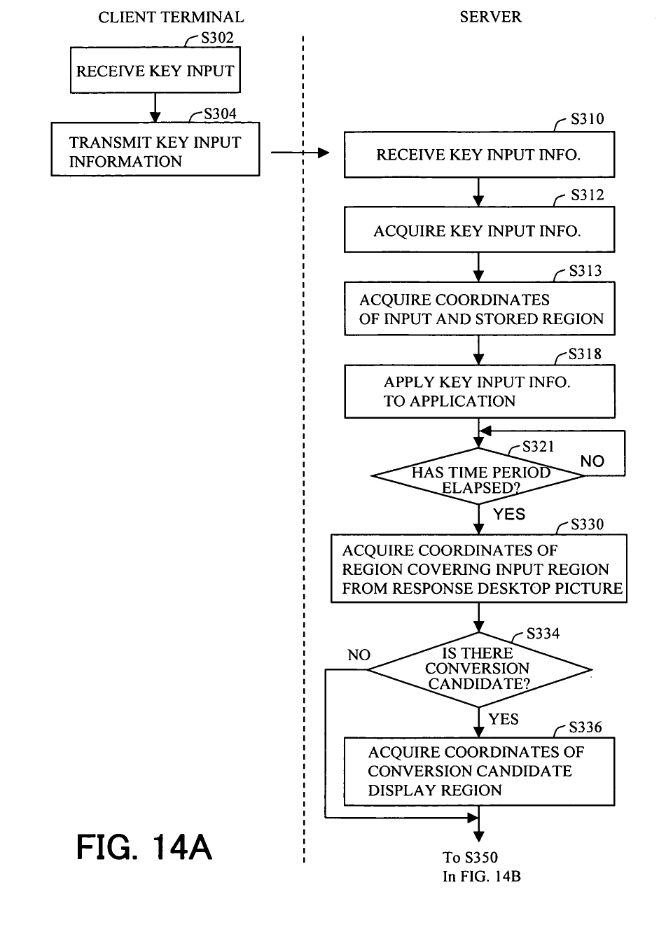

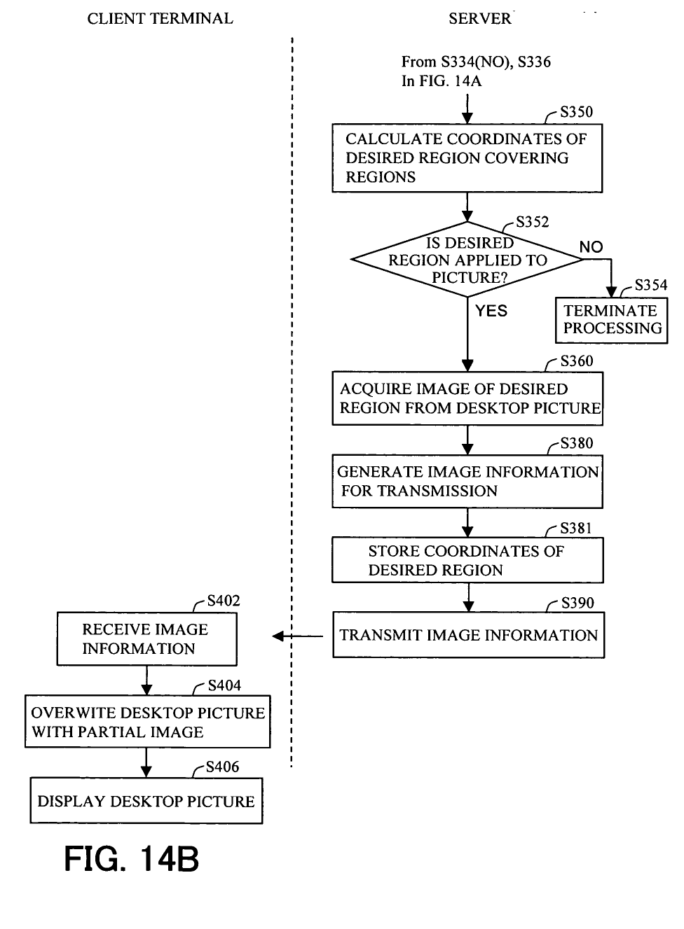

FIGS. 14A and 14B are an example of a flow chart of the quick response processing executed by the server 100 in response to the key input information from the client terminal 200, in accordance with the configuration of the server 100 of FIG. 13.

Referring to FIG. 14A, Steps 302 to 304 executed by the client terminal 200 are similar to those of FIG. 10A.

Referring to FIG. 14A, Steps 310 to 312 executed by the server 100 are similar to those of FIG. 10A. At Step 313, the Japanese input region coordinate acquisition unit 152 of the acquired region coordinate determiner unit 144 retrieves the previously transmitted acquired region coordinate data from the region in the memory 104. Referring to FIGS. 14A and 14B, Steps 318 to 350 executed by the server 100 are similar to those of FIGS. 10A and 10B.

At Step 352 following Steps 334 (the NO branch) and 350, the region-suitability determiner unit 146 calculates the area of the desired image region in accordance with the coordinate positions of the desired image region. The region-suitability determiner unit 146 then compares the area with the threshold value in the determination threshold storage unit 147, to determine as to whether the desired image region to be acquired is to be applied to the desktop picture for displaying on the client terminal 200 for quick response.

If the area of the desired image region exceeds the threshold value, the region-suitability determiner unit 146 determines that it is not applicable, and hence terminates the processing at Step 354. If the area of the desired image region does not exceed the threshold value, the region-suitability determiner unit 146 determines that it is applicable. After that, the procedure goes to Step 360.

Steps 360 to 380 are similar to those of FIG. 10B. At Step 381, the region-suitability determiner unit 146 stores the current acquired region coordinate data to be transmitted into the region in the memory 104 for possible later use. Thus, even if the desired image region is not transmitted to the client terminal 200, coordinate data of a last transmitted desired image region can be acquired at Step 313 of FIG. 14A occurring later. Step 390 is similar to that of FIG. 10B. When the desktop picture processor unit 170 cyclically transmits the image information of the entire desktop picture to the client terminal 200, the input and quick response processor unit 140 may delete the acquired region coordinate data in the region in the memory 104, or alternatively store the acquired region coordinate data of the entire desktop picture to be transmitted into the region in the memory 104.

Steps 402 to 406 executed by the client terminal 200 are similar to those of FIG. 3.

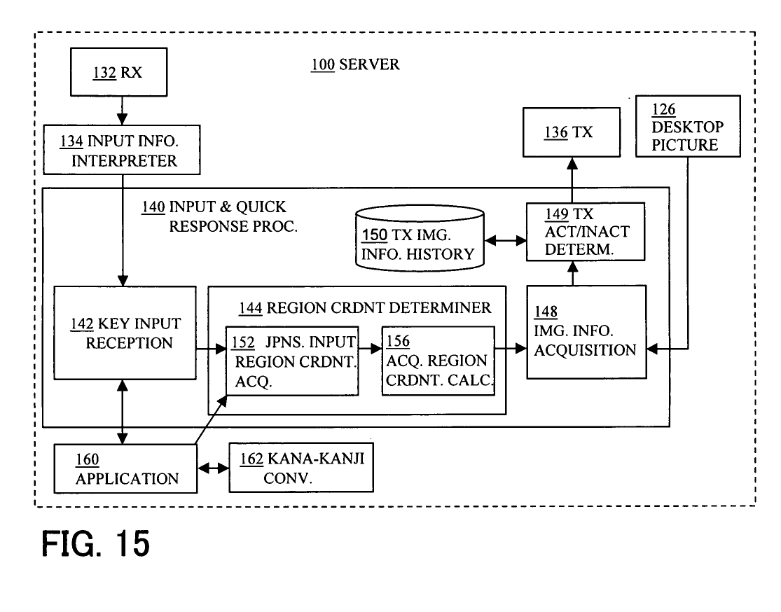

FIG. 15 is a modification of the embodiment of FIG. 5, and illustrates an example of a further configuration of the input and quick response processor unit 140 and its relevant portions of the server 100 for quick response processing of the key input information in the kana-kanji conversion by the application 160 as illustrated in FIGS. 4A and 4B, in accordance with a still further embodiment of the invention. This embodiment is applicable also to other embodiments illustrated in FIGS. 9 and 11 and described below.

In FIG. 15, the input and quick response processor unit 140 of the server 100 includes a transmission activation/inactivation determiner unit 149 and a transmitted image information history storage unit 150 (a region in the memory 104) in addition to the input reception unit 142, the acquired region coordinate determiner unit 144, and the image information acquisition unit 148.

The transmission activation/inactivation determiner unit 149 compares the current image information to be transmitted with the previous image information in the transmitted image information history storage unit 150. If the current image information matches with the previous image information, the current image information is not transmitted. If the current image information does not match with the previous image information, the current image information is transmitted. When it is transmitted, the transmission activation/inactivation determiner unit 149 stores the transmitted image information into the transmitted image information history storage unit 150. Alternatively, the hash value of the current image information may be compared with that of the previous image information, to determine as to whether the current image information matches with the previous image information. This prevents futile or redundant processing for transmission of the image information, and hence prevents an increase in the transmission load and an increase in the processing load in the client terminal 200. The other elements and operations of the input and quick response processor unit 140 are similar to those of FIG. 5.

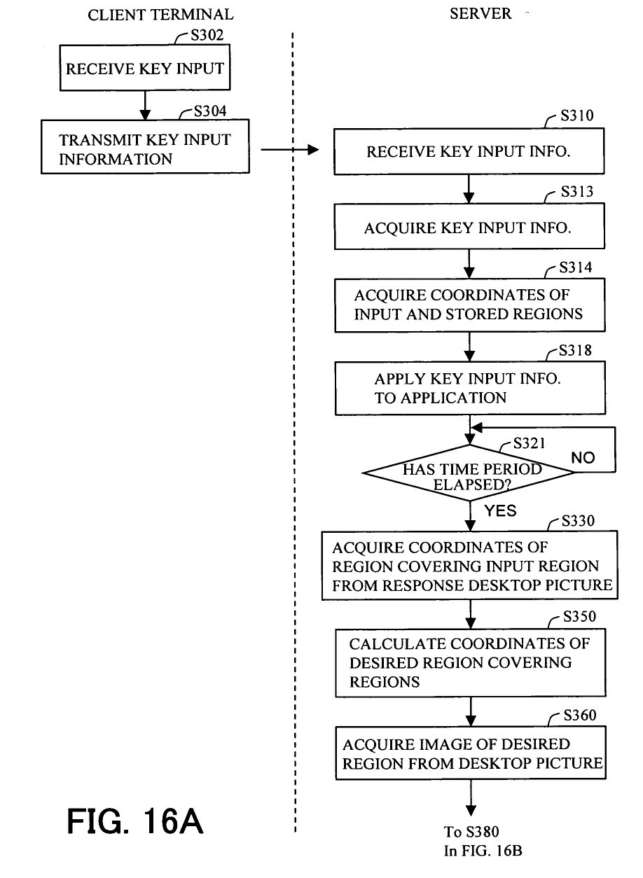

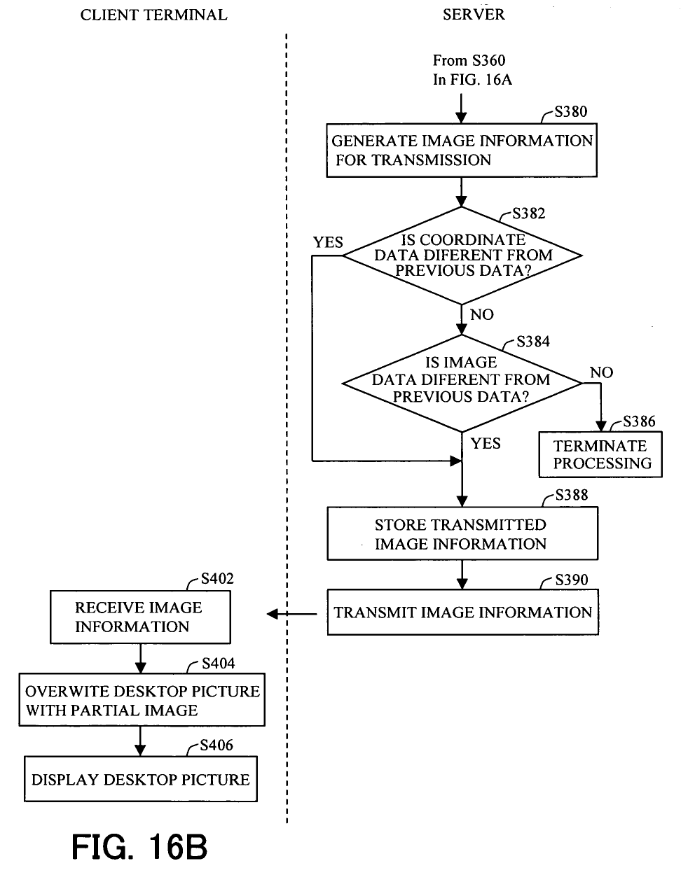

FIGS. 16A and 16B are an example of a flow chart of the quick response processing executed by the server 100 in response to the key input information from the client terminal 200, in accordance with the configuration of the server 100 of FIG. 15.

Referring to FIG. 16A, Steps 302 to 304 executed by the client terminal 200 are similar to those of FIG. 6.

Referring to FIG. 16A, Steps 310 to 312 executed by the server 100 are similar to those of FIG. 10A. At Step 313, the transmission activation/inactivation determiner unit 149 further retrieves coordinate data and image data of the previously stored transmitted image information from the transmitted image information history storage unit 150. Referring to FIGS. 16A and 16B, Steps 318 to 380 are similar to those of FIGS. 10A and 10B.

At Step 382 following Step 380, the transmission activation/inactivation determiner unit 149 compares the current coordinate data (numerical values) in the current image information to be transmitted with the previous coordinate data in the image information in the transmitted image information history storage unit 150, to determine as to whether the current coordinate data (numerical values) in the image information to be transmitted is different from the stored previous coordinate data. If it is determined that it is different, the procedure goes to Step 388.

If it is determined at Step 382 that the coordinate data is not different from the previous coordinate data, i.e., it is the same as the previous coordinate data, the transmission activation/inactivation determiner unit 149 at Step 384 compares the current image data (or individual pixel values) in the image information to be transmitted with the previous image data in the image information in the transmitted image information history storage unit 150, to determine as to whether the image data (or pixel values) in the current image information to be transmitted is different from the stored previous image data. If it is determined that it is different, the procedure goes to Step 388.

If it is determined at Step 384 that the image data is not different from the previous image data, i.e., it is the same as the previous image data, the transmission activation/inactivation determiner unit 149 terminates the processing for transmission.

At Step 388, the transmission activation/inactivation determiner unit 149 stores the image information to be transmitted into the transmitted image information history storage unit 150 for possible later use. The transmission activation/inactivation determiner unit 149 may store the hash value of the image information into the transmitted image information history storage unit 150. Thus, even if the desired image region is not transmitted to the client terminal 200, coordinate data of a last transmitted desired image region can be acquired at Step 313 of FIG. 16A occurring later. When the desktop picture processor unit 170 cyclically transmits the image information of the entire desktop picture to the client terminal 200, the input and quick response processor unit 140 may delete the acquired region coordinate data in the transmitted image information history storage unit 150, or alternatively store the image information of the entire desktop picture to be transmitted into the transmitted image information history storage unit 150.

Step 390 is similar to that of FIG. 10B.

Steps 402 to 406 executed by the client terminal 200 are similar to those of FIG. 10B.

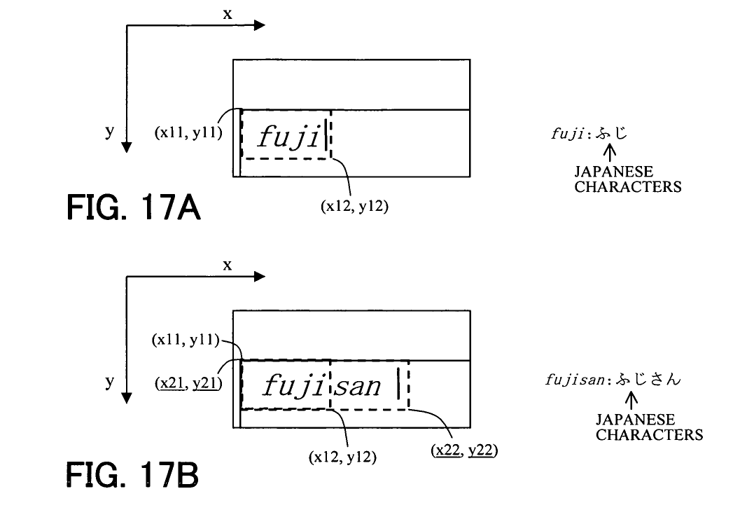

FIGS. 17A and 17B illustrate examples of display images of the input regions of respective desktop pictures before and after the reflection of a plurality of key inputs (e.g., hiragana character inputs “sa” and “n”) in the kana-kanji conversion processing, in accordance with a still further embodiment of the invention.

In FIG. 17A, the range of the display image region for two hiragana characters “fuji” is defined by a pair of coordinate positions {(x11, y11), (x12, y12)}. For the alphabetic input of hiragana characters, the display image in the input image region as a result of an alphanumeric key input “s” is then changed to “fuji-s” (the two hiragana characters and an alphabet character), which as a result of an alphanumeric key input “a” and the alphabet-hiragana conversion is then changed to “fujisa” (three hiragana characters), which as a result of an alphanumeric key input “n” is then changed to “fujisa-n” (the three hiragana characters and an alphabet character), which as a result of another alphanumeric key input “n” and the alphabet-hiragana conversion is then changed to the string of four hiragana characters “fujisan”, where the hyphens are added for clarity. In FIG. 17B, the range of the display image region for the hiragana characters “fujisan” is defined by a pair of coordinate positions {(x21, y21), (x22, y22)}.

For a quick response to the plurality of pieces of key input information, the server 100 transmits the first image information in the range {(x11, y11), (x12, y12)} of the display image region for the two hiragana characters “fuji”, and then transmits the second image information in the range {(x21, y21), (x22, y22)} of the display image region for the four hiragana characters “fujisan”. The server 100 may not transmit the intermediate image information of the display images “fuji-s”, “a”, “fujisa”, and “fujisa-n” between the display images of two strings of hiragana characters “fuji” and “fujisan”. Thus, the processing loads for the transmission and the reception are advantageously reduced in the server 100 and the client terminal 200.

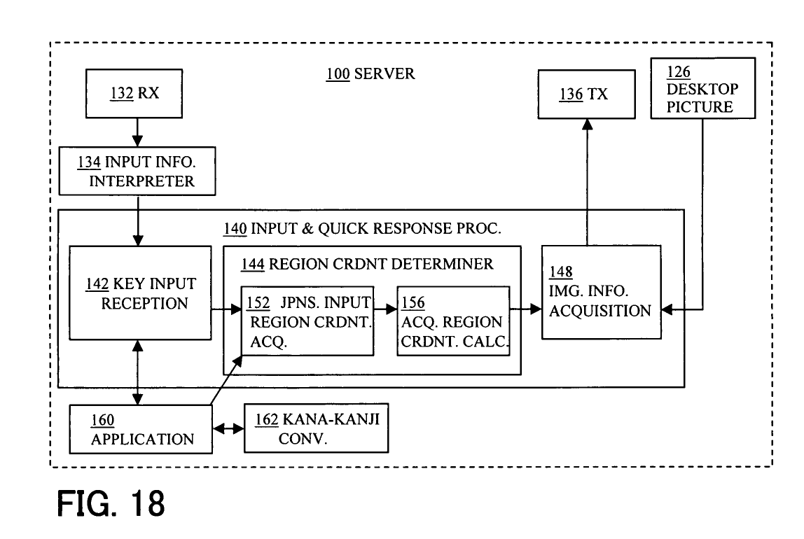

FIG. 18 illustrates an example of a configuration of the input and quick response processor unit 140 and its relevant portions of the server 100 for quick response processing of the key input information in the kana-kanji conversion by the application 160 as illustrated in FIGS. 17A and 17B, in accordance with a still further embodiment of the invention.

Referring to FIG. 18, the input and quick response processor unit 140 of the server 100 includes a configuration similar to that of FIG. 5. In this case, the Japanese input region coordinate acquisition unit 152 of the input and quick response processor unit 140 does not acquire the coordinates of the input image region from the API of the kana-kanji converter unit 162 for the application 160, until the number of pieces of received key input information exceeds a given threshold number of pieces of input information or alternatively until the timer indicates an elapse of a given time period. After the number of pieces of received input information exceeds the given threshold number of pieces of input information or alternatively the timer indicates the elapse of the given time period, the Japanese input region coordinate acquisition unit 152 acquires the coordinates of the input image region from the API of the kana-kanji converter unit 162 for the application 160. The other elements and operations of the input and quick response processor unit 140 are similar to those of FIG. 5.

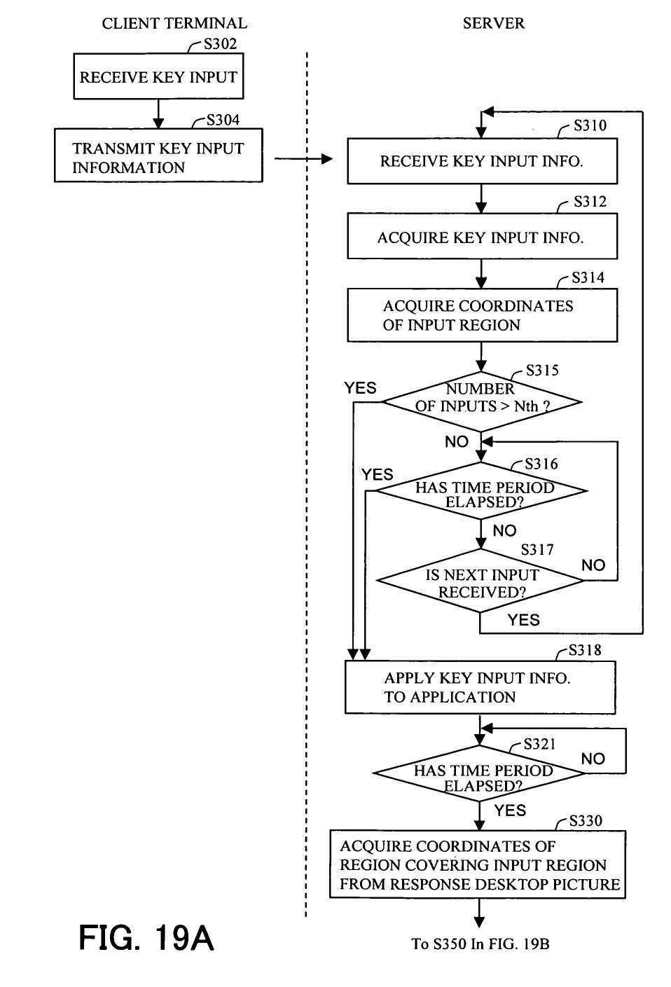

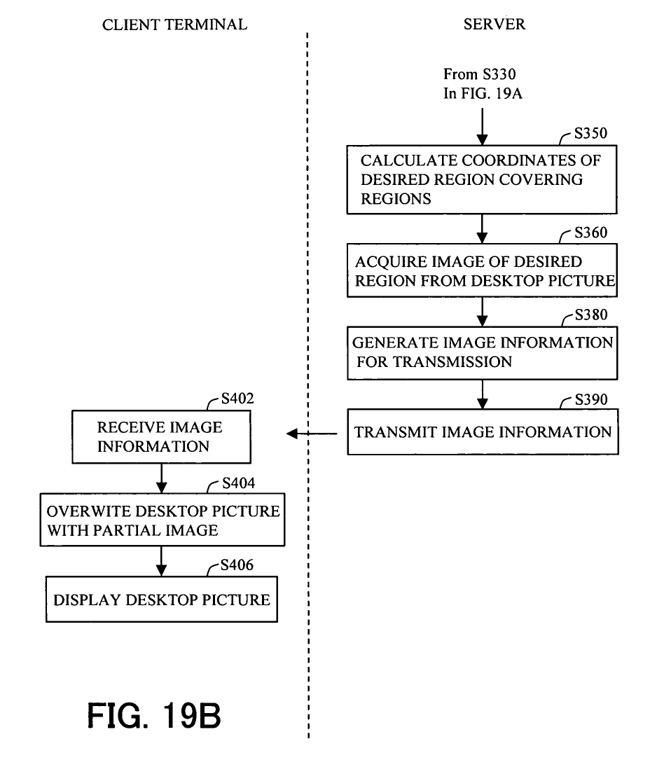

FIGS. 19A and 19B are an example of a flow chart of the quick response processing executed by the server 100 in response to the key input information from the client terminal 200, in accordance with the configuration of the server 100 of FIG. 18.

Referring to FIG. 19A, Steps 302 to 304 executed by the client terminal 200 are similar to those of FIG. 6.

Steps 310 to 314 executed by the server 100 are similar to those of FIG. 6.

At Step 315 following Step 314, the Japanese input region coordinate acquisition unit 152 determines whether the number, N, of pieces of received key input information exceeds a given threshold number of pieces of input information (e.g., three). If it is determined that the number of received key input information pieces exceeds the given threshold number of pieces of input information, the procedure goes to Step 318. If it is determined that the number of pieces of received key input information does not exceed the given threshold number of pieces of input information, the Japanese input region coordinate acquisition unit 152 at Step 316 determines whether a given time period (e.g., 50 ms) has elapsed. If it is determined that the given time period has elapsed, the procedure goes to Step 318.

If it is determined at Step 316 that the given time period does not yet elapse, the Japanese input region coordinate acquisition unit 152 at Step 317 determines whether the next key input has been received. If it is determined that the next input has been received, the procedure returns to Step 310. If it is determined that the next input is not yet received, the procedure returns to Step 316.

Steps 318 to 330 are similar to those of FIG. 6.

Referring to FIG. 19B, Steps 350 to 390 are similar to those of FIG. 6.

Steps 402 to 406 executed by the client terminal 200 are similar to those of FIG. 6.

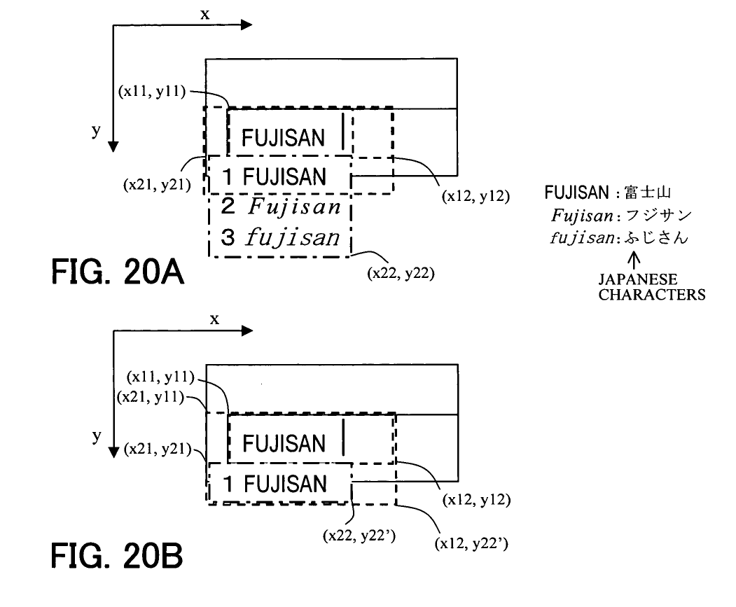

FIGS. 20A and 20B illustrate examples of display images of the input region and an associated conversion candidate display region of respective desktop pictures before and after the reflection of an input of a conversion key, i.e., before the kana-kanji conversion and after tentative kana-kanji conversion in the kana-kanji conversion processing, in the server 100, in accordance with a still further embodiment of the invention. FIG. 20B illustrates determination of the coordinate positions of another desired image region which covers or includes the display image region of only one conversion candidate within the entire conversion candidate window rather than the display image region of the entire conversion candidate window of FIG. 20A as the desired image region.

In FIG. 20A, similarly to FIG. 8A, in accordance with the ranges of the input image regions for the string of four hiragana characters “fujisan” yet to be converted and for the string of three kanji characters “FUJISAN” after the tentative conversion (not yet finally determined), a desired image region is calculated in accordance with the processing as illustrated in FIG. 7. Then, the resultant tentative desired image region is defined by a pair of coordinate positions {(x11, y11), (x12, y12)}, while the range of the display image region of the list of conversion candidate character strings is defined by a pair of coordinate positions {(x21, y21), (x22, y22)}. The range of the image region of one candidate character string at the top in the display image region of the list of conversion candidate character strings is defined by a pair of coordinate positions {(x21, y21), (x22, y22′)}.

In FIG. 20B, a larger desired image region which reflects the key input information and which includes a display region of only desired one conversion candidate character string in the display region of the list of conversion candidate character strings is defined by a pair of coordinate positions {(x21, y11), (x12, y22′)}. In this manner, by taking into consideration the image region of current selected one candidate character string in the display image region of the list of conversion candidate character strings, the processing loads for the transmission and the reception are advantageously reduced in the server 100 and the client terminal 200, independently of the number of conversion candidate character strings.

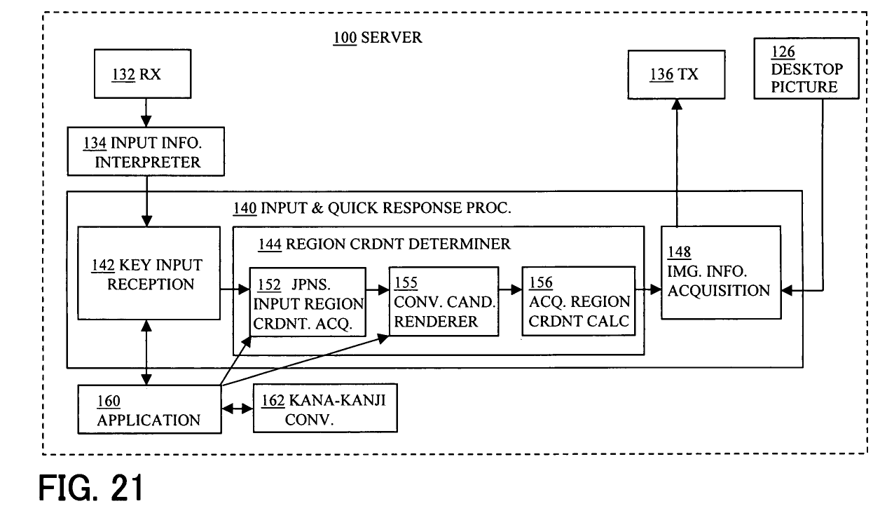

FIG. 21 is a modification of the embodiment of FIG. 9, and illustrates an example of a still further configuration of the input and quick response processor unit 140 and its relevant portions of the server 100 for quick response processing of the key input information in the kana-kanji conversion by the application 160 as illustrated in FIGS. 20A and 20B, in accordance with a still further embodiment of the invention.

In FIG. 21, in the input and quick response processor unit 140 of the server 100, the acquired region coordinate determiner unit 144 includes a conversion candidate renderer unit 155 in addition to the Japanese input region coordinate acquisition unit 152 and the acquired region coordinate calculator unit 156.

In response to the reception of the key input from the input reception unit 142, the Japanese input region coordinate acquisition unit 152 acquires the coordinates of the Japanese character input region from the API of the kana-kanji converter unit 162 for the application 160, and then provides the acquired coordinates to the acquired region coordinate calculator unit 156. The conversion candidate renderer unit 155 acquires, from the API of the kana-kanji converter unit 162 for the application 160, a string of characters of one current selected conversion candidate of the conversion candidate display region, then renders the string of characters as an image. The conversion candidate renderer unit 155 then acquires the coordinate positions of the rendered image region, and then provides the acquired coordinate positions to the acquired region coordinate calculator unit 156. Then, in accordance with the Japanese character input region coordinate positions and with the conversion candidate rendered region coordinate positions, the acquired region coordinate calculator unit 156 calculates the coordinates or a pair of coordinate positions of a larger desired image region to be acquired, and then provides the coordinate positions of the desired image region to the image information acquisition unit 148. The other elements and operations of the input and quick response processor unit 140 are similar to those of FIG. 5 or 9.

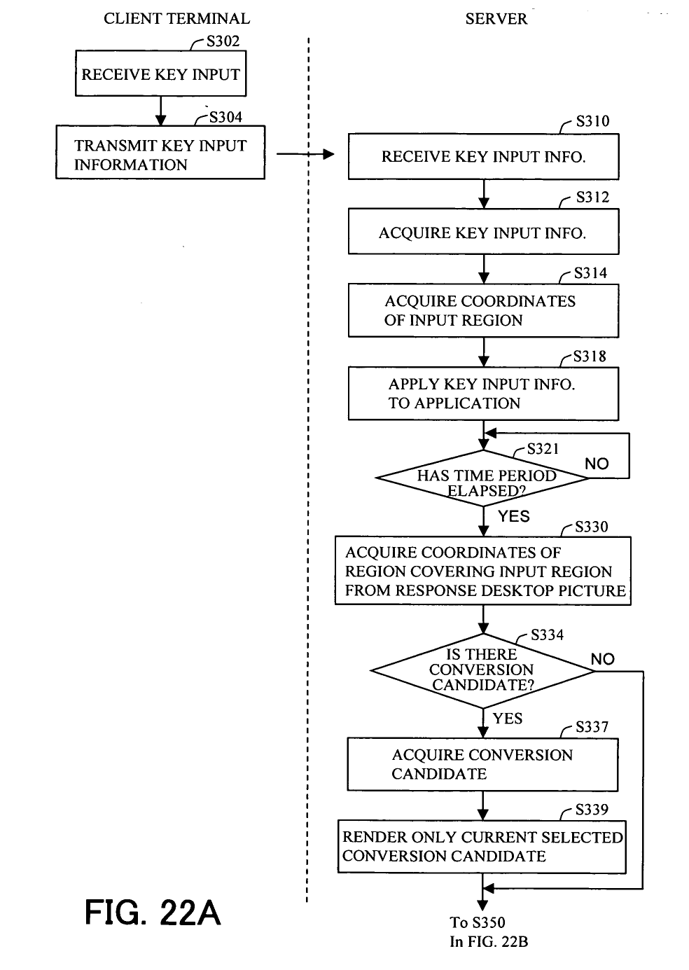

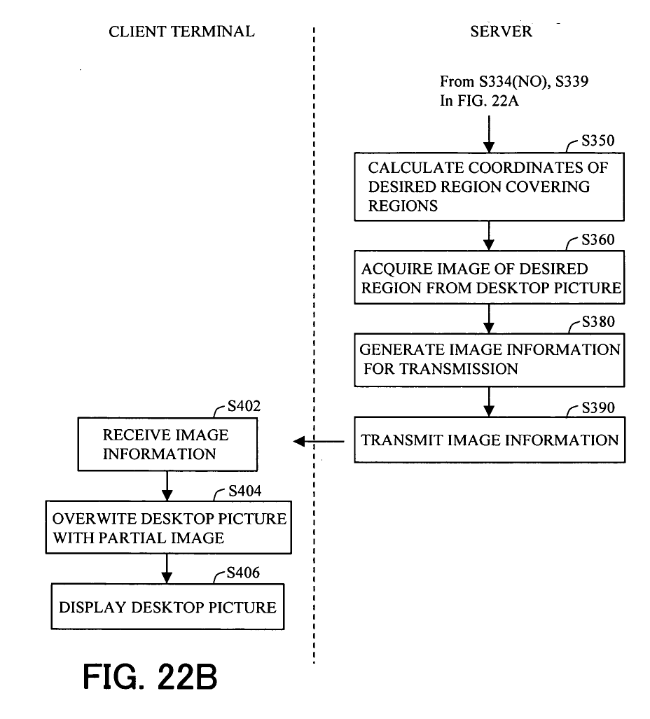

FIGS. 22A and 22B are an example of a flow chart of the quick response processing executed by the server 100 in response to the key input information from the client terminal 200, in accordance with the configuration of the server 100 of FIG. 21.

Referring to FIG. 22A, Steps 302 to 304 executed by the client terminal 200 are similar to those of FIG. 10.

Steps 310 to 334 executed by the server 100 are similar to those of FIG. 10A.

If it is determined at Step 334 that there is a conversion candidate, the conversion candidate renderer unit 155 of the acquired region coordinate determiner unit 144 at Step 337 acquires conversion candidate data from the application 160. At Step 339, the conversion candidate renderer unit 155 acquires, from the application 160, the coordinates (x21, y21) of the conversion candidate display region and the character string of the current selected conversion candidate. Then, the conversion candidate renderer unit 155 renders, in the desktop picture storage region 126, the character string of the current selected one conversion candidate displayed in the input image region, into the region {(x21, y21), (x22, y22′)} for one conversion candidate character string {(x21, y21), (x21+Δx, y22+Δy′)}. The conversion candidate renderer unit 155 provides, to the acquired region coordinate calculator unit 156, the coordinate positions {(x21, y21), (x22, y22′)} of the region for one conversion candidate character string.

Referring to FIG. 22B, Steps 350 to 390 are similar to those of FIG. 10B.

Steps 402 to 406 are similar to those of FIG. 10B.

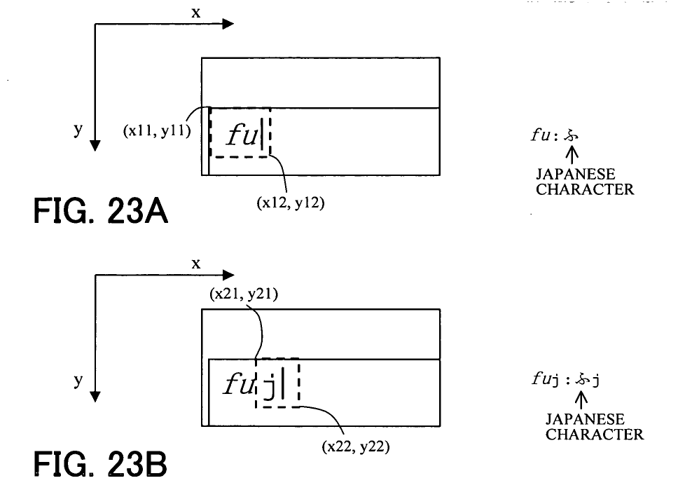

FIGS. 23A and 23B illustrate examples of display images of the input regions of respective desktop pictures before and after the reflection of a response by the application 160 to an alphanumeric key input “j”, following a hiragana character “fu” which is displayed in the input image region in response to input alphabet characters “fu” or an input hiragana character “fu” in the kana-kanji conversion processing, in accordance with a still further embodiment of the invention.

In FIG. 23A, key input alphabets “fu” are first provided through the keyboard so that the hiragana character with the caret, “fu|”, is displayed. In this case, the range of a changed image region within the input image region is defined by a pair of coordinate positions {(x11, y11), (x12, y12)}. The server 100 predicts this changed image region in accordance with the received key input information, and then transmits, to the client terminal 200, the image information of only the changed image region.

In FIG. 23B, a key input alphabet “j” is then provided through the keyboard so that the hiragana character and the alphabet character with the caret in combination, “fu-j|”, are displayed. In this case, the range of a changed display image region within the input image region is defined by a pair of coordinate positions {(x21, y21), (x22, y22)}. The server 100 predicts this changed image region in accordance with the received key input information, and then transmits, to the client terminal 200, the image information of only the changed image region {(x21, y21), (x22, y22)}. This reduces the processing load in the server 100.

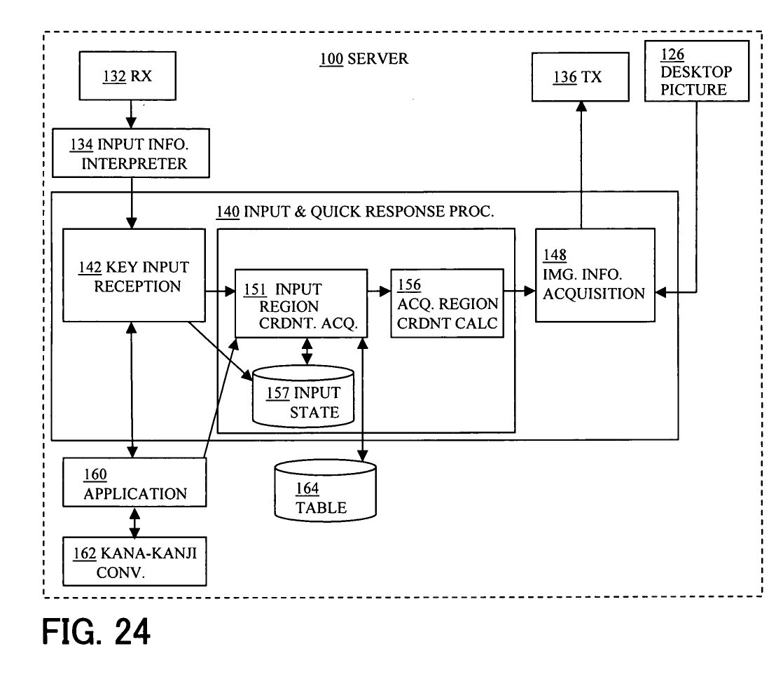

FIG. 24 illustrates an example of a configuration of the input and quick response processor unit 140 and its relevant portions of the server 100 for quick response processing of the key input information in the kana-kanji conversion by the application 160 as illustrated in FIGS. 23A and 23B, in accordance with a still further embodiment of the invention.

In FIG. 24, the server 100 includes a table storage unit 164 (a region in the memory 104) connected to the input and quick response processor unit 140. In the input and quick response processor unit 140 of the server 100, the acquired region coordinate determiner unit 144 includes an input region coordinate determiner unit 151 having a function of looking up a table, and an input state storage unit 157 (a region in the memory 104), in addition to the acquired region coordinate calculator unit 156.

The input state storage unit 157 stores a current input state of the application 160. A table stored in the table storage unit 164 indicates coordinate positions of a desired image region in a corresponding, subsequent input state which is determined in relation to the current input state and the content of a new input. In response to the current key input information from the input reception unit 142, the input region coordinate determiner unit 151 looks into the table storage unit 164, to determine a corresponding, subsequent input state in accordance with the current input state stored in the input state storage unit 157 and with the content of the new input, and determines the coordinate positions of the desired input image region in the subsequent input state. The other elements and operations of the input and quick response processor unit 140 are similar to those of FIG. 5.

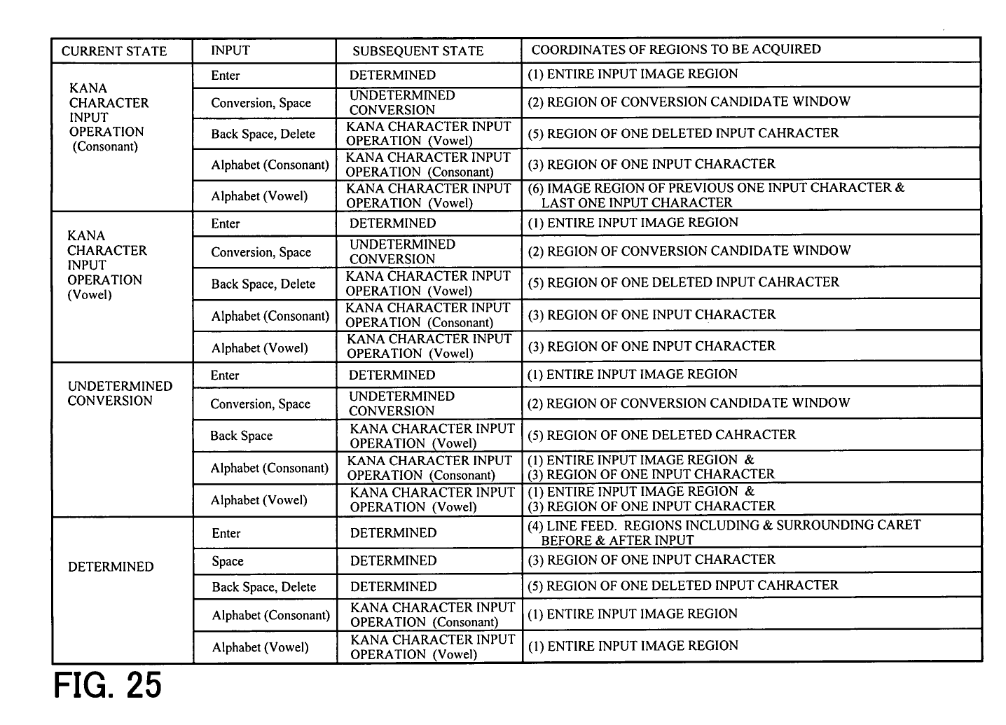

FIG. 25 illustrates an example of elements of a table store in the table storage unit 164.

In FIG. 25, there are four possible input operation states, which include: a “determined” or “committed” state appearing as an initial input state or occurring as a result of an operation of finally determining, committing or selecting one character or character string from a set of candidate characters and/or character strings in the kana-kanji conversion; an intermediate state “kana character input operation (consonant alphabet)” indicating that an alphabet indicative of a consonant of the Japanese language is inputted or keyed for a phonetic or kana character before the kana-kanji conversion; an intermediate state “kana character input operation (vowel alphabet)” indicating that an alphabet indicative of a vowel of the Japanese language is inputted or keyed for a phonetic or kana character before the kana-kanji conversion; and an undetermined state “undetermined conversion” indicating that the kana-kanji conversion is currently active, and is yet to finally determine or commit a selected kanji or kana character or a selected string of kanji and/or kana characters.

In the current state “kana character input operation (consonant alphabet)”, when a key input “Enter” is generated, the application enters into the state “determined”. In this case, the entire input image region is determined as a desired image region. The entire input image region is similar to that of FIGS. 4A and 4B and at Step 330 of FIG. 6.

In the current state “kana character input operation (consonant alphabet)”, when a key input for kana-kanji conversion with the “conversion” key or the “space” bar is generated, the application enters into the state “undetermined conversion”. In this case, the display region of the conversion candidate window is determined as a desired image region. The display image region of the conversion candidate window is similar to that of FIGS. 8A and 8B and at Step 336 of FIG. 10.

In the current state “kana character input operation (consonant alphabet)”, when a key input “Back Space” or “Delete” is generated, the application enters into the state “kana character input operation (vowel alphabet)”, the display region for the one deleted character is determined as a desired region. In this case, the display image region is acquired in accordance with the caret coordinates and the character font size after the character deletion.

In the current state “kana character input operation (consonant alphabet)”, when a key input “alphabet character (of a consonant)” (e.g., b, c, or d) is generated or keyed, the state “kana character input operation (consonant alphabet)” is maintained. In this case, the display image region for the one input character is determined as a desired image region. In this case, the display image region is acquired in accordance with the caret coordinates and the character font size after the character input.

In the current state “kana character input operation (consonant alphabet)”, when a key input “alphabet character (vowel)” (e.g., a, e, or i) is generated, the application enters into the state “kana character input operation (vowel alphabet)”. In this case, the display image region for the previously one input character and the latest one input character is determined as a desired image region.

In the current state “kana character input operation (vowel alphabet)”, when the key input “Enter” is generated, the application enters into the state “determined”. In this case, the entire input image region is determined as a desired image region.

In the current state “kana character input operation (vowel alphabet)”, when the key input “conversion” or “space” is generated, the application enters into the state “undetermined conversion”. In this case, the display image region of the conversion candidate window is determined as a desired image region.

In the current state “kana character input operation (vowel alphabet)”, when the key input “Back Space” or “Delete” is generated, the state “kana character input operation (vowel alphabet)” is maintained. In this case, the display image region for the one deleted character is determined as a desired image region.

In the current state “kana character input operation (vowel alphabet)”, when a key input “alphabet character (of a consonant)” is generated, the application enters into the state “kana character input operation (consonant alphabet)”. In this case, the display image region for the one input character is determined as a desired image region.

In the current state “kana character input operation (vowel alphabet)”, when a key input “alphabet character (of a vowel)” is generated, the state “kana character input operation (vowel alphabet)” is maintained. In this case, the display image region for the one input character is determined as a desired image region.

In the current state “undetermined conversion”, when the key input “Enter” is generated, the application enters into a state “determined”. In this case, the entire input image region is determined as a desired image region.

In the current state “undetermined conversion”, when the key input “conversion” or “space” is generated, the state “undetermined conversion” is maintained. In this case, the display image region of the conversion candidate window is determined as a desired image region.

In the current state “undetermined conversion”, when the key input “Back Space” is generated, the application enters into the state “kana character input operation (vowel alphabet)”. In this case, the display image region for the one deleted character is determined as a desired image region.

In the current state “undetermined conversion”, when a key input “alphabet character (of a consonant)” is generated, the application enters into the state “kana character input operation (consonant alphabet)”. In this case, a combination of the entire input region and the display image region for the one input character is determined as a desired image region.

In the current state “undetermined conversion”, when a key input “alphabet character (of a vowel)” is generated, the application enters into the state “kana character input operation (vowel alphabet)”. In this case, a combination of the entire input region and the display image region for the one input character is determined as a desired image region. In this case, the display image region is acquired in accordance with the caret coordinates before the character input, the caret coordinates after the character input, and the character font size.

In the current state “determined”, when the key input “Enter” is generated as a line feed, the state “determined” is maintained. In this case, the display image region including and surrounding the caret before and after the character input is determined as a desired image region. That is, the image region for one character containing the caret before the line feed and one character containing the caret after the line feed is determined as a desired image region.

In the current state “determined”, when the key input “space” is generated, the state “determined” is maintained. In this case, the display image region for the one input character is determined as a desired image region.

In the current state “determined”, when the key input “Back Space” or “Delete” is generated, the state “determined” is maintained. In this case, the display image region for the one deleted character is determined as a desired image region.

In the current state “determined”, when a key input “alphabet character key (of a consonant)” is generated, the application enters into the state “kana character input operation (consonant alphabet)”. In this case, the entire input region is determined as a desired image region.

In the current state “determined”, when a key input “alphabet character (of a vowel)” is generated, the application enters into the state “kana character input operation (vowel alphabet)”. In this case, the entire input region is determined as a desired image region.

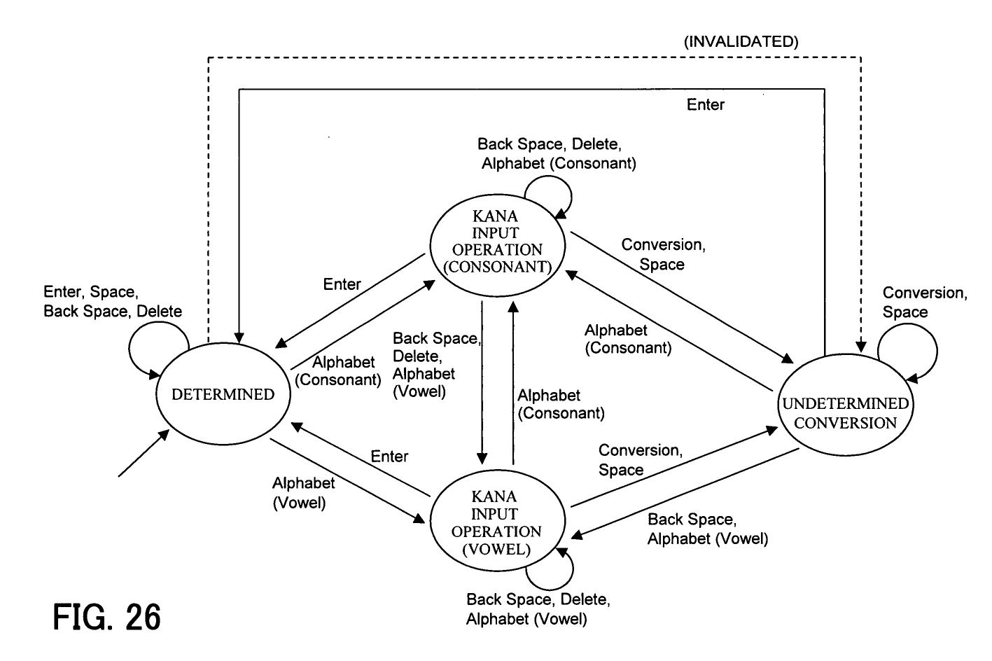

FIG. 26 illustrates an example of a state transition diagram for key inputs in the respective current input states of FIG. 25.

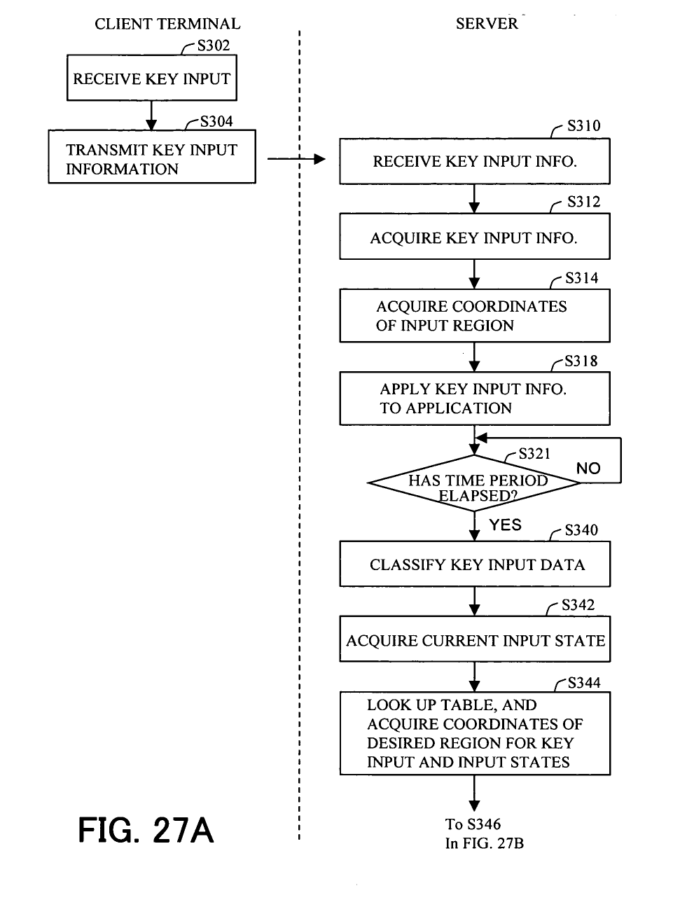

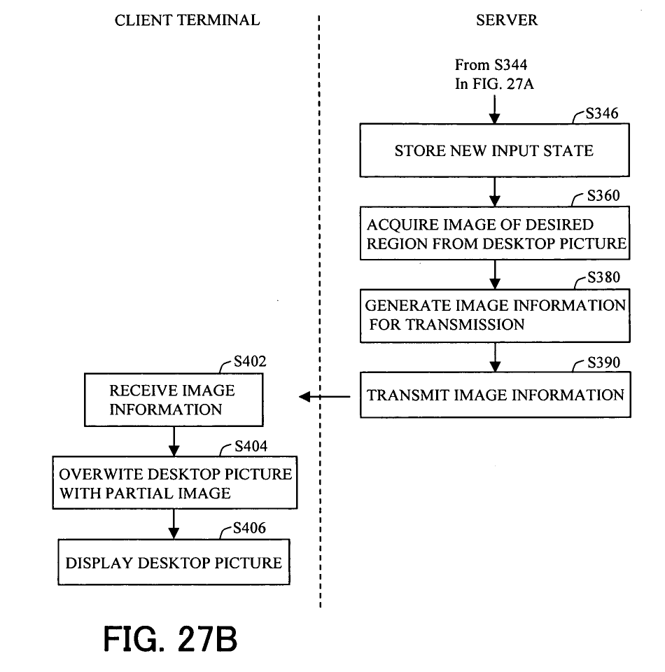

FIGS. 27A and 27B are an example of a flow chart of the quick response processing executed by the server 100 in response to the key input information from the client terminal 200, in accordance with the configuration of the server 100 of FIG. 24.

Referring to FIG. 16A, Steps 302 to 304 executed by the client terminal 200 are similar to those of FIG. 6.

Steps 310 to 321 executed by the server 100 are similar to those of FIG. 6.

At Step 340 following the YES branch of Step 321, in accordance with the table of FIG. 25, the input region coordinate determiner unit 151 classifies the data of the key inputs received from the input reception unit 142. At Step 342, the input region coordinate determiner unit 151 acquires the current input state by looking into the input state storage unit 157.

At Step 344, the input region coordinate determiner unit 151 looks up the table in the table storage unit 164, and acquires and determines a subsequent input state in accordance with the content of the new key input for the current input state. The input region coordinate determiner unit 151 then acquires the coordinate positions of a corresponding desired image region, and then provides the coordinate positions to the acquired region coordinate calculator unit 156.

Referring to FIG. 27B, at Step 346, the input region coordinate determiner unit 151 saves or stores the new, determined subsequent input state into the input state storage unit 157.

Steps 360 to 390 are similar to those of FIG. 6.

Steps 402 to 406 are similar to those of FIG. 6.

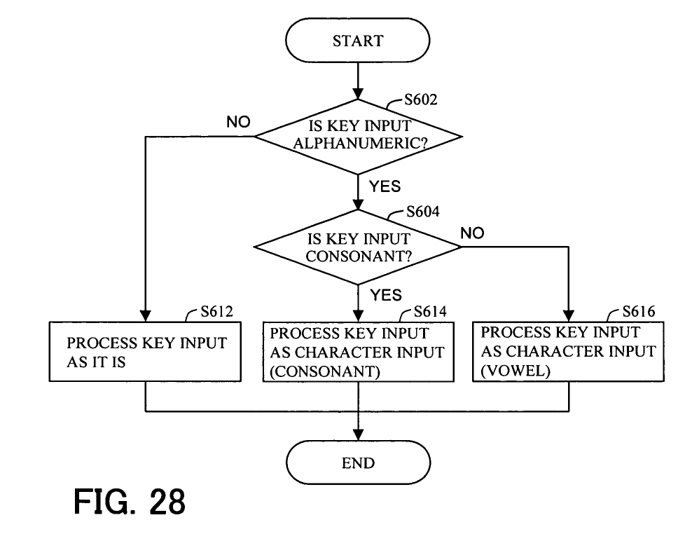

FIG. 28 is an example of a detailed flow chart for Step 340 of FIG. 27A.

At Step 602, the input region coordinate determiner unit 151 determines whether the key input represents an alphanumeric character. If it is determined that it is not an alphanumeric character, the input region coordinate determiner unit 151 at Step 612 processes the key input as it is or non-alphabet character input.

If it is determined at Step 602 that it is an alphanumeric character, the input region coordinate determiner unit 151 further at Step 604 determines whether the key input is an alphabet consonant character. If it is determined that it is an alphabet consonant character, the input region coordinate determiner unit 151 at Step 614 classifies the key input as an “alphabet character (of a consonant)”. If it is determined that it is not an alphabet consonant character, the input region coordinate determiner unit 151 at Step 616 classifies the key input as an “alphabet character (of a vowel)”.

All examples and conditional language recited herein are intended for pedagogical purposes to aid the reader in understanding the invention and the concepts contributed by the inventors to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A server apparatus for use in a thin-client system and for processing in accordance with input information received from a terminal device via a network, the server apparatus comprising:
a receiver unit that receives an input event from the terminal device;
an input event processing unit that applies the received input event to particular processing related to the received input event;
a region determiner unit that dynamically determines, as a desired region, a partial image region from a resultant display picture generated by the particular processing, so that the partial image region is affected by the particular processing;
a region image generator unit that generates, as partial image information, partial image data of the desired region and position data of the desired region, in accordance with data of the display picture; and
a transmitter unit that transmits the generated partial image information to the terminal device.

2. The server apparatus according to claim 1, further comprising a display data generator unit that compresses the data of the display picture to generate display data in a given cycle, wherein
the transmitter unit further transmits the display data to the terminal device, and
the display data is decompressed by the terminal device into non-compressed data of the display picture, and the partial image data is combined by the terminal device with previously transmitted, non-compressed data of the display picture.

3. The server apparatus according to claim 1, wherein the region determiner unit determines the desired region in accordance with an input region of the display picture before the input event is applied to the particular processing and with an input region of the display picture after the input event is applied to the particular processing.

4. The server apparatus according to claim 2, wherein the region determiner unit determines the desired region in accordance with an input region of the display picture before the input event is applied to the particular processing and with an input region of the display picture after the input event is applied to the particular processing.

5. The server apparatus according to claim 1, wherein the region determiner unit acquires the input region from an operating system when a code type of the received input event is of one-byte code, and
the region determiner unit acquires the input region from character conversion software when a code type of the received input event is other than of one-byte code.

6. The server apparatus according to claim 4, wherein the region determiner unit acquires the input region from an operating system when a code type of the received input event is of one-byte code, and
the region determiner unit acquires the input region from character conversion software when a code type of the received input event is other than of one-byte code.

7. The server apparatus according to claim 1, further comprising a transmission determiner unit that determines whether the partial image information is to be transmitted, in accordance with an amount of the partial image information to be transmitted or with a difference of the partial image information from previously transmitted partial image information.

8. The server apparatus according to claim 2, further comprising a transmission determiner unit that determines whether the partial image information is to be transmitted, in accordance with an amount of the partial image information to be transmitted or with a difference of the partial image information from previously transmitted partial image information.

9. The server apparatus according to claim 1, wherein the transmission determiner unit determines whether the partial image information is to be transmitted, in accordance with an area of the desired region determined by the region determiner unit.

10. The server apparatus according to claim 2, wherein the transmission determiner unit determines whether the partial image information is to be transmitted, in accordance with an area of the desired region determined by the region determiner unit.

11. The server apparatus according to claim 1, wherein the transmission determiner unit determines whether the partial image information is to be transmitted, in accordance with content of the partial image information.

12. The server apparatus according to claim 2, wherein the transmission determiner unit determines whether the partial image information is to be transmitted, in accordance with content of the partial image information.

13. The server apparatus according to claim 1, wherein the region determiner unit determines the desired region in accordance with an input region of the display picture before the input event is applied to the particular processing, and with an input region of the display picture after the input event is applied to the particular processing, and with a display region of a conversion candidate window after the input event is applied to the particular processing.

14. The server apparatus according to claim 2, wherein the region determiner unit determines the desired region in accordance with an input region of the display picture before the input event is applied to the particular processing, and with an input region of the display picture after the input event is applied to the particular processing, and with a display region of a conversion candidate window after the input event is applied to the particular processing.

15. The server apparatus according to claim 1,; further comprising a character conversion candidate renderer unit that acquires data of character conversion candidates from a character conversion function used in processing related to the input event, then selects at least one character conversion candidate from the data of character conversion candidates, and then renders the selected at least one conversion candidate in a display region of the conversion candidate window.

16. The server apparatus according to claim 2, further comprising a character conversion candidate renderer unit that acquires data of character conversion candidates from a character conversion function used in processing related to the input event, then selects at least one character conversion candidate from the data of character conversion candidates, and then renders the selected at least one conversion candidate in a display region of the conversion candidate window.

17. The server apparatus according to claim 1, further comprising:
an input state holding unit that holds a current input state corresponding to a previous input event; and
a table storage unit that stores a table that indicates a subsequent input state and a desired region which correspond to a new input event received in the current input state, wherein
the region determiner unit determines the desired region by accessing the table storage unit in accordance with the current input state held in the input state holding unit and the current input event.

18. The server apparatus according to claim 2, further comprising:
an input state holding unit that holds a current input state corresponding to a previous input event; and
a table storage unit that stores a table that indicates a subsequent input state and a desired region which correspond to a new input event received in the current input state, wherein
the region determiner unit determines the desired region by accessing the table storage unit in accordance with the current input state held in the input state holding unit and the current input event.
